(19) United States
(12) Patent Application Publication
(10) Pub. No.: US 2018/0226716 A1
(43) Pub. Date: Aug. 9, 2018

(54) COMMUNICATION SHEET AND COMMUNICATION SYSTEM

(71) Applicant: Teijin Limited, Osaka-shi, Osaka (JP)

(72) Inventors: Junko TANABE, Osaka (JP); Mitsuhiro HAKOZAKI, Tokyo (JP)

(73) Assignee: Teijin Limited, Osaka-shi, Osaka (JP)

(21) Appl. No.: 15/749,805

(22) PCT Filed: Aug. 25, 2016
(86) PCT No.: PCT/JP2016/074841

§ 371 Date: Feb. 2, 2018

(30) Foreign Application Priority Data
Aug. 31, 2015 (JP) 2015-171205
Jul. 6, 2016 (JP) 2016-134548

(51) Int. Cl. H01Q 5/15; H01Q 9/42; H01Q 19/13

(52) U.S. Cl. CPC H01Q 5/15; H04B 5/02; H01Q 19/138; H01Q 9/42

(57) ABSTRACT

A first sheet-like conductor (10) of a communication sheet (100) has a plurality of openings defined by a plurality of intersecting linear conductors (11). A second sheet-like conductor is a flat plate facing the first sheet-like conductor (10) with a gap therebetween. A wireless board (20) has a linear antenna that extends parallel to one linear conductor (11a) among the plurality of intersecting linear conductors (11).

### TECHNICAL FIELD

The present disclosure relates to a communication sheet and a communication system.

### BACKGROUND ART

In recent years, communication sheets for localizing radio waves on the surface of a two-dimensional sheet without radiating radio waves into a three-dimensional space have been put to practical use. This communication sheet uses radio waves (so-called evanescent waves) leaking from the sheet having openings to a near field to perform two-dimensional communication.

Regarding this communication sheet, Patent Literature 1 discloses a dedicated connector that serves as an interface between a radio transmission source and a communication sheet. The technique disclosed in Patent Literature 1 allows radio waves transmitted from the transmission source to travel through a coaxial cable, so that the radio waves propagate to the communication sheet via the dedicated connector mounted on the sheet surface.

### CITATION LIST

### Patent Literature

Patent Literature 1: Unexamined Japanese Patent Application Kokai Publication No. 2007-82178

### SUMMARY OF INVENTION

### Technical Problem

It is conceivable that the radio transmission source may be a radio transmitter such as a beacon which intermittently transmits (broadcasts) signals in three-dimensional space. Generally, a radio transmitter is an SOC (System-on-a-chip) device, and circuitry and an antenna in the radio transmitter, which are necessary for radio transmission are put together on a single board for miniaturization. It is conceivable to integrate this miniaturized wireless board with a communication sheet and perform two-dimensional communication in an apparently completely cableless fashion.

However, wireless boards are generally designed to broadcast signals into space, and are not suitable for combination with the communication sheet from the specification wise view. In other words, merely incorporating the wireless board into the communication sheet causes a large difference in propagation efficiency and the loss of radio waves depending on the mounting mode. For this reason, radio waves do not uniformly propagate within the communication sheet, resulting in uneven radio waves leakage on the sheet surface.

Meanwhile, it takes time and cost to develop a dedicated connector for physically connecting a wireless board and a communication sheet together. In addition, even when a dedicated connector is developed, it is necessary to acquire various technical standard conformity certificates (so-called techniques suitable) in order to apply dedicated connector to the wireless board, which increases the number of man-hours and the cost.

In view of the above, it is desired to design a communication sheet incorporating a radio transmission source such that radio waves leach out on the sheet surface uniformly while suppressing the number of man-hours and the cost.

The present disclosure has been made in view of the above-described circumstances, and an object of the present disclosure is to provide a communication sheet or the like that allows radio waves to leach out on the sheet surface uniformly while suppressing the number of man-hours and the cost.

### Solution to Problem

A communication sheet according to a first aspect of the present disclosure includes:

a first sheet-like conductor having a plurality of openings defined by a plurality of intersecting linear conductors;

a second sheet-like conductor of a flat plate facing the first sheet-like conductor with a gap therebetween; and

a wireless board having a linear antenna parallel to one of the plurality of intersecting linear conductors.

The wireless board may be disposed on a major surface of the first sheet-like conductor so that a direction of current flowing through the linear antenna and the direction of interconnection of the one linear conductor are the same, and

the first sheet-like conductor may include a removal hole which is a contact region with the wireless board set on the major surface from which a region containing other linear conductors excluding the one linear conductor is removed.

In addition, the linear antenna may be partially or entirely a meander line,

the wireless board may be disposed on the major surface of the first sheet-like conductor so that a center line of the meander line substantially overlaps the one linear conductor.

In addition, the linear antenna may be a linear antenna pattern, and

the wireless board may be disposed on the major surface of the first sheet-like conductor so that the antenna pattern and the one linear conductor substantially overlap with each other.

Further, the communication sheet may further include:

a dielectric provided between the first and second sheet-like conductors;

a through hole penetrating through the dielectric and the second sheet-like conductor directly underlying the removal hole; and

a metal plate covering an opening portion of the through hole that faces the linear antenna from the second sheet-like conductor side.

The metal plate may be a metal tape for bonding the wireless board and the second sheet-like conductor via the through hole.

Further, the communication sheet further may include:

a sheet-like battery that supplies power to the wireless board, the sheet-like battery being attached to that side of the communication sheet which is opposite to a side thereof where the second sheet-like conductor is in contact with the dielectric.

It is preferable that in addition to the linear antenna, the wireless board includes a signal generator for generating a signal transmitted by the linear antenna, and

the first sheet-like conductor causes the signal transmitted from the linear antenna to propagate from the one linear conductor into the communication sheet and leach out from the plurality of openings to a near field.

The first sheet-like conductor may have a lattice shape having a plurality of openings defined by a plurality of intersecting linear conductors.

The wireless board may be a beacon that transmits a signal conforming to Bluetooth (registered trademark) Low Energy (BLE) from the linear antenna.

A communication system according to a second aspect of the present disclosure is a communication system including the communication sheet, and a terminal device, wherein

the communication sheet transmits a beacon signal including guidance specifying information for specifying guidance information of an exhibit placed near the communication sheet, and

upon reception of the beacon signal in proximity to the communication sheet, the terminal device outputs an image or sound based on the guidance information.

The communication system may include a plurality of communication sheets, and may further include a server and a storage device, wherein

each of the plurality of communication sheets may transmit a beacon signal including guidance specifying information for specifying guidance information of an exhibit placed near the local communication sheet and identification information of the local communication sheet,

the storage device may store position information indicating a position where each of the plurality of communication sheets is disposed,

upon reception of the beacon signal, the terminal device may transmit, to the server, the identification information of the communication sheet which has transmitted the beacon signal and the identification information of the terminal device,

upon reception of the identification information of the communication sheet which has transmitted the beacon signal from the terminal device and the identification information of the terminal device, the server may store, in the storage device, history information in which the identification information of the communication sheet which has transmitted the beacon signal and the identification information of the terminal device, and time information indicating a time of the reception are associated with each other, and

the server may output information indicating a route that the terminal device has moved based on the history information and the position information.

A communication system according to a third aspect of the present disclosure is a communication system including the communication sheet and a terminal device, wherein

the communication sheet transmits a beacon signal including position information indicating a position where the communication sheet is disposed, and

upon reception of the beacon signal in proximity to the communication sheet, the terminal device outputs an image or sound based on the position information.

A communication system according to a fourth aspect of the present disclosure is a communication system including the communication sheet, a terminal device, a server, and a processor, wherein

the communication sheet transmits a beacon signal,

upon reception of the beacon signal in proximity to the communication sheet, the terminal device transmits the identification information of the terminal device to the server, and

upon reception of the identification information of the terminal device from the terminal device, the server transmits information associated with the identification information of the terminal device to the processor.

A communication system according to a fifth aspect of the present disclosure is a communication system including the communication sheet, a terminal device, and a server, wherein

the communication sheet is provided in a target facility, and transmits a beacon signal including identification information of the target facility,

the server transmits the identification information of the target facility to the terminal device, and

after receiving the identification information of the target facility from the server, the terminal device outputs a control signal for using the target facility upon reception of the beacon signal in proximity to the communication sheet.

A communication system according to a sixth aspect of the present disclosure is a communication system including the communication sheet, a terminal device, and a processor, wherein

the communication sheet is provided in the processor, and transmits a beacon signal including identification information of the processor,

upon reception of the beacon signal in proximity to the communication sheet, the terminal device transmits the identification information of the processor and the identification information of the terminal device to the processor, and

upon reception of the identification information of the processor from the terminal device, the processor executes processing based on the identification information of the terminal device.

A communication system according to a seventh aspect of the present disclosure is a communication system including the communication sheet, a first terminal device, and a second terminal device, wherein

the communication sheet transmits a beacon signal including identification information of the communication sheet, and

upon reception of the beacon signal in proximity to the communication sheet, the first terminal device transmits the identification information of the communication sheet to the second terminal device.

### Advantageous Effects of Invention

According to the present disclosure, it is possible to reduce the number of man-hours and the cost, and allow radio waves to leach out onto the sheet surface evenly.

### BRIEF DESCRIPTION OF DRAWINGS

FIG. 1A is a top plan view for illustrating the configuration of a communication sheet according to an embodiment of the present disclosure;

FIG. 1B is a cross-sectional view taken along line A-A in FIG. 1A for illustrating the configuration of a communication sheet according to an embodiment of the present disclosure;

FIG. 1C is a rear plan view for illustrating the configuration of a communication sheet according to an embodiment of the present disclosure;

FIG. 2 is an enlarged perspective view of a meander line of a wireless board

FIG. 3 is a top plan view of a communication sheet according to a comparative example;

FIG. 4 is a diagram showing an electric field strength distribution of a communication sheet according to an embodiment;

FIG. 5 is a diagram showing a field strength distribution of a communication sheet according to a comparative example;

FIG. 6 is a view showing an electric field strength distribution of a communication sheet without a metal tape;

FIG. 7 is a diagram showing a change in maximum gain in the presence or absence of a metal tape;

FIG. 8A is a top plan view for illustrating the configuration of a communication sheet according to Modification 1;

FIG. 8B is a cross-sectional view taken along line A-A in FIG. 8A for illustrating the configuration of a communication sheet according to Modification 1;

FIG. 9A is a cross-sectional view of a communication sheet according to Modification 2;

FIG. 9B is a cross-sectional view of a communication sheet according to Modification 3;

FIG. 9C is a cross-sectional view of a communication sheet according to Modification 4;

FIG. 10 is a diagram for illustrating the configuration of a communication sheet according to Modification 5;

FIG. 11 is a diagram for illustrating a first use example of the communication sheet;

FIG. 12 is a diagram for illustrating a second use example of the communication sheet;

FIG. 13 is a diagram for illustrating a fourth use example of the communication sheet

FIG. 14 is a diagram for illustrating a fifth use example of the communication sheet;

FIG. 15 is a diagram for illustrating an eleventh use example of a communication sheet; and

FIG. 16 is a diagram for illustrating a twelfth use example of the communication sheet.

### DESCRIPTION OF EMBODIMENTS

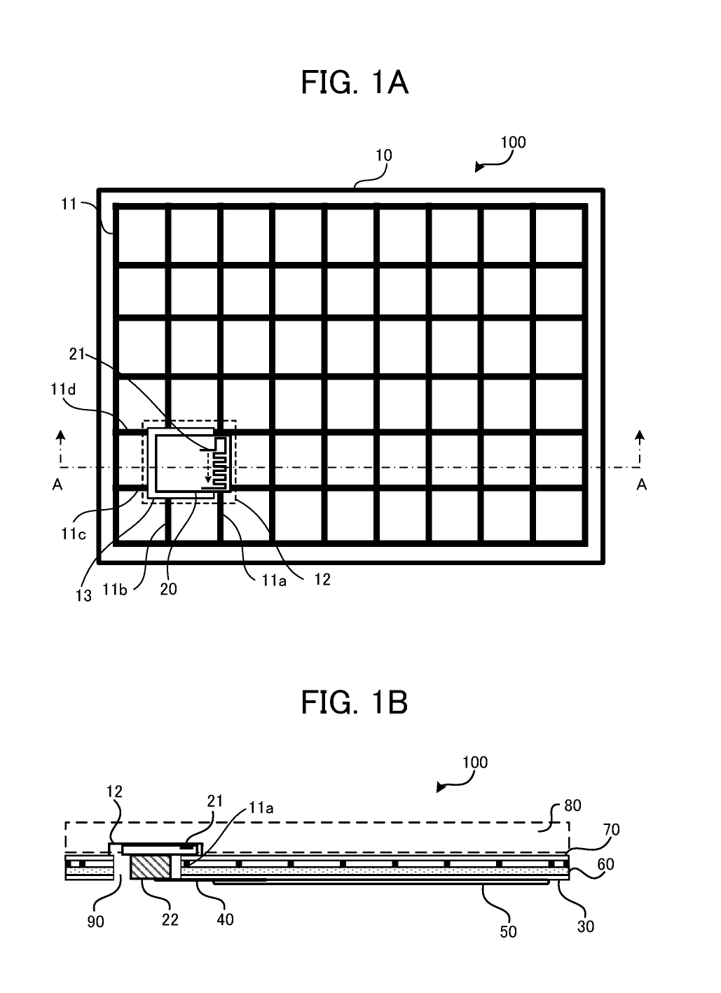

The following describes a communication sheet according to an embodiment of the present disclosure with reference to FIGS. 1A, 1B, and 1C. FIG. 1A is a top plan view, FIG. 1B is a sectional view taken along line A-A, and FIG. 1C is a bottom plan view. The top and bottom are equivalent to above and below, the top plan is a view seen from above, and the bottom plan is a view from below.

As shown in FIG. 1A, the communication sheet 100 includes a first sheet-like conductor 10. The first sheet-like conductor 10 is in the form of a lattice (so-called mesh) having a plurality of openings defined by a plurality of intersecting linear conductors 11.

As shown in the figure, s wireless board 20 is placed on the major surface of the first sheet-like conductor 10. This wireless board 20 is a beacon that transmits a signal of the 2.4 GHz band conforming to Bluetooth (registered trademark) Low Energy (BLE). The wireless board 20 includes a meander line 21 as a linear antenna that transmits a signal (transmits a radio wave). The meander line 21 overlaps with the one linear conductor 11a among the plurality of linear conductors 11 in a plan view. Further, the wireless board 20 is disposed on the major surface of the first sheet-like conductor 10 such that the direction of the current flowing through the meander line 21 (the portion indicated by the broken line in the figure) and the wiring direction of the one linear conductor 11a are the same.

Here, the term “overlap” includes the case of overlapping by leaving a gap (in this embodiment, by the thickness of the wireless board 20, overlapping with a gap), a case of overlapping with no gap. In this embodiment, it is assumed that “signal” and “radio wave” are synonymous, and any one of them will be used as appropriate. Further, that linear conductor in the contact area between the wireless board 20 and the first sheet-like conductor 10 which overlaps with the meander line 21 in the same direction is denoted by reference numeral 11a, and the other linear conductors except the linear conductor 11a are denoted by 11b to 11d, respectively.

As shown in the figure, the first sheet-like conductor 10 has a removal hole 13 from which a region including the other linear conductors 11b to 11d except for the linear conductor 11a is removed out of the contact region with the wireless board 20. The communication sheet 100 is provided with a fixing member 12 for protecting the wireless board 20 exposed to the outside, and covering and fixing the wireless board 20. The fixing member 12 is made of a material other than metals (for example, plastic) from the viewpoint of enhancing the designability. For ease of understanding, while the wireless board 20 is transparently displayed in the figure, it is in fact covered with the fixing member 12 and is not visible. It should be noted that the number of the linear conductors 11 is described as an example in the case where the number of the linear conductors 11 is ten in the longitudinal direction, and seven in the lateral direction. The linear conductors 11a to 11d are simply referred to as the linear conductors 11 unless it is necessary to specifically describe any of the linear conductors 11a to 11d.

As shown in FIG. 1B, the communication sheet 100 has a three-layer structure that includes a dielectric 60 between a meshed first sheet-like conductor 10 and a second sheet-like conductor 30 in the form of a flat plate facing the first sheet-like conductor 10 with a gap therebetween. The sheet material (the material of the first and second sheet-like conductors) is optional as long as it is a conductor, but in this embodiment, the sheet material is aluminum as an example. The dimension (length×width×thickness) of the sheet material is, for example, 20 cm×30 cm×32 μm. Herein, “sheet-like” means that it has an extension as a two-dimensional plane, and the thickness is sufficiently less than the wavelength of the frequency to be used.

On the other hand, the dielectric 60 is preferably a material having a low dielectric constant suitable for a high-frequency board (particularly, 2.4 GHz band of BLE), and in this embodiment, it is made of foamed polyolefin as an example. The dimension of the dielectric 60 is, for example, 20 cm×30 cm×about 1 mm. A protective film 70 such as PET (PolyEthylene Terephthalate) or the like is adhered onto the major surface of the first sheet-like conductor 10 in preparation for spilling water or the like. Therefore, to be precise, the wireless board 20 is mounted on the major surface of the first sheet-like conductor 10 via the protective film 70. However, this protective film 70 is not indispensable. It should be noted that the major surface of the first sheet-like conductor 10 refers to a surface opposite to the contact surface in contact with the dielectric 60.

In addition to the meander line 21, the wireless board 20 further includes a chip (signal generating unit) 22 that generates a signal transmitted from the meander line 21. This chip 22 has a one-chip configuration of a processor (control microcomputer) for controlling radio transmission and its peripheral circuits (crystal oscillator, clock circuit, etc.), and is covered with a shield case for protection. As shown in the figure, the communication sheet 100 has a through hole 90 that directly underlies the removal hole 13 and penetrates the dielectric 60 and the second sheet-like conductor 30. The through hole 90 is a hole bored in a region including the linear conductors 11b to 11d, excluding the linear conductor 11a, and includes a removal hole 13 bored only in the first sheet-like conductor 10.

As shown in the figure, the wireless board 20 is bonded and fixed to the ceiling surface of the fixing member 12 in a state in which the chip 22 is inserted through the through hole 90. Although the bonding method is optional, for example, an adhesive may be applied between the fixing member 12 and the wireless board 20, or a double-sided tape may be attached to the fixing member 12 and the wireless board 20.

Further, the communication sheet 100 is provided with a metal tape 40 that covers at least the opening portion of the through hole 90 that faces the meander line 21 from the side of the second sheet-like conductor 30. The metal tape 40 is a metal plate having an adhesive property, for example, a copper tape. The metal tape 40 adheres the wireless board 20 and the second sheet-like conductor 30 via the through hole 90.

Now, the manner of mounting the wireless board 20 is described in detail below. The wireless board 20 is disposed on the major surface of the first sheet-like conductor 10 such that (i) the direction of the current flowing through the meander line 21 is the same as the interconnecting direction of the linear conductor 11a, and (ii) the meander line 21 and the linear conductor 11a overlap with each other.

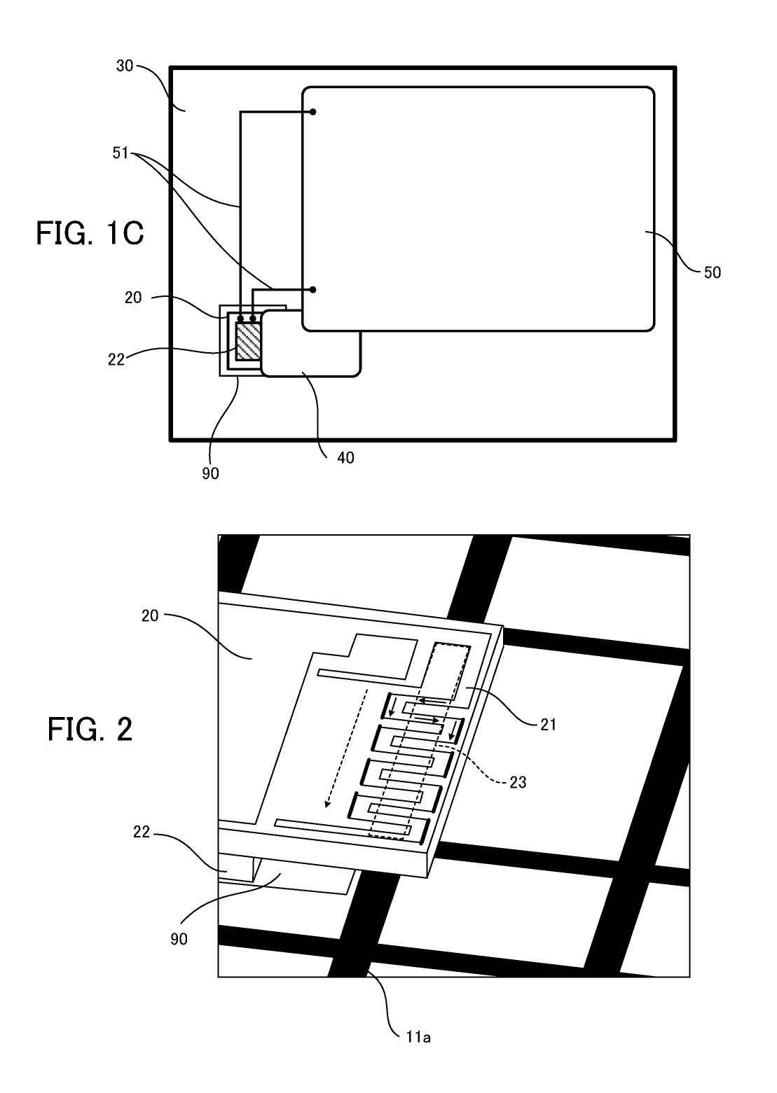

With respect to (ii), as shown in an enlarged perspective view of FIG. 2, the wireless board 20 is disposed on the major surface of the first sheet-like conductor 10 such that a center line 23 of the meander line 21 and the linear conductor 11a substantially overlap with each other. Here, the center line 23 means a line that passes through the middle points of all the widthwise lines at all the portions of the meander line 21 which are formed so as to meander by alternately connecting a plurality of widthwise (horizontal) lines (wirings) and depthwise (vertical) lines (wirings), and it is usually a straight line. With respect to (i), the direction of the current flowing through the meander line 21 indicated by the broken line arrow in the figure and the wiring direction of the linear conductor 11a are the same. The direction of the local current is a meandering solid arrow, but the direction of the current becomes the dashed arrow as viewed from a global perspective point.

As shown in FIG. 2, the center line 23 equidistant from the radiating portion (the thick line portion in the figure) where the electric waves radiate without the electric currents canceling in the direction of the electric current (indicated by the solid line arrow in the figure) will almost overlap with the linear conductor 11a a gap therebetween. It is to be noted that “substantially” means to allow some deviation (for example, deviation of about several mm) if not overlapping completely. Also, since the actual current is an alternating current, the traveling direction is reversed, but the principle of the radiating part does not change even if it is reversed. In addition, there is no change in the point that the direction of the current and the wiring direction of the linear conductor 11a are the same even if they are reversed.

Here, signal transmission from the wireless board 20 to the sheet-like conductor 10 is performed by electromagnetic field coupling between the parallel flat plates (between the meander line 21 and the linear conductor 11a). Therefore, as shown in FIG. 1B, at least the meander line 21 needs to be parallel to the linear conductor 11a. Herein, “parallel” means that opposing surfaces (the linear antenna and the linear conductor 11a) are parallel to each other, and also means that the direction of the current of the linear antenna (the meander line 21) and the wiring direction of the linear conductor 11a are parallel to each other. That is, in case of different directions (for example, the linear antenna and the linear conductor 11a cross each other), the case is consciously excluded.

In addition, from the viewpoint of increasing the coupling force by electromagnetic field coupling, it is preferable that the area where both (the meander line 21 and the linear conductor 11a) overlap with each other is wide and the distance therebetween is short. In this embodiment, therefore, with respect to the meander line 21 which is difficult to completely overlap, an imaginary center line 23 equidistant from the radiating portion is superimposed on the linear conductor 11a.

Also, if there is another conductor near the linear conductor 11a, the electric field distribution changes, and the coupling force of the electromagnetic field coupling between the meander line 21 and the linear conductor 11a decreases. That is, electromagnetic field coupling also occurs between the meander line 21 and the other linear conductors 11b to 11d other than the linear conductor 11a, and the coupling force between the meander line 21 and the linear conductor 11a is reduced. If the coupling force decreases, it is likely that no electric field is generated between the linear conductor 11a and the second sheet-like conductor 30, and the propagation efficiency of radio waves in the communication sheet 100 decreases. Therefore, in this embodiment, the electric field is trapped (concentrated on one side) in the linear conductor 11a overlapping with the meander line 21, so that the removal hole 13 from which the other linear conductors 11b to 11d that may become noise are removed is provided.

Further, as shown in FIG. 1B, the wireless board 20 and the second sheet-like conductor 30 are adhered by the metal tape 40. This is to prevent transmitted radio waves from leaking through the through hole 90 and escaping outside. In particular, radio waves tend to escape from the through hole 90 in the vicinity immediately below the meander line 21. Therefore, in this embodiment, a metal tape 40 is used instead of the second sheet-like conductor 30 serving as a shield so as to cover at least the opening portion facing the meander line 21. As a result, the metal tape 40, like the second sheet-like conductor 30, functions as a shield and a ground.

In this way, the wireless board 20 is mounted on the major surface of the first sheet-like conductor 10 so that the meander line 21 and the linear conductor 11a are parallel and overlap in the same direction. In addition, a through hole 90 is formed by removing the other linear conductors 11b to 11d. In this way, the meander line 21 and the linear conductor 11a are strongly coupled, and the first sheet-like conductor 10 transmits a signal transmitted from the meander line 21 from the linear conductor 11a to the communication sheet 100 propagate and leach out from the multiple openings to the near field.

That is, the signal propagates between the first and second sheet-like conductors 10, 30 within the communication sheet 100, and exudes (leaches out) through the mesh-like opening. In other words, the microwaves of the BLE propagate between the first sheet-like conductor 10 and the second sheet-like conductor 30, and at that time, the microwave passes through the surface of the sheet-like conductor 10 having openings leak out in the very vicinity (near field). The region of this near field is the leaching region 80 shown by the broken line in FIG. 1B. Accordingly, the signal transmitted from the wireless board 20 is localized in the leaching region 80. Since the signal transmitted by the wireless board 20 is shielded on the side of the second sheet-like conductor 30, a signal leaches out to the first sheet-like conductor 10 side.

The preferable mounting mode of the wireless board 20 and the mechanism of signal transmission have been described above. It is to be noted that it is sufficient for at least the meander line 21 and the linear conductor 11a to be parallel with respect to the mounting form of the wireless board 20, and it is not indispensable that the point where the both are overlapped with each other and the through hole 90 is provided. This point will be described in detail later.

Returning to FIG. 1B, the communication sheet 100 includes a sheet-like battery 50 for supplying power to the wireless board 20, the sheet-like battery 50 being adhered to that side of the communication sheet 100 which is opposite to the side where the second sheet-like conductor 30 contacts the dielectric 60 (See FIG. 1C). The sheet-like battery 50 is a sheet-like lithium ion battery having a thickness of, for example, about 0.4 mm. As shown in FIG. 1C, the sheet-like battery 50 is connected to terminals of both polarities (plus and minus) of the wireless board 20 by a conducting wire 51.

This connection of the power supply prevents the metal tape 40 from being adhered so as to cover the entire through hole 90. However, this is a problem of interconnection routing, and as long as power may be supplied, the metal tape 40 may be adhered so as to cover the entire through hole 90. While the method of fixing the sheet-like battery 50 is optional, the sheet-like battery 50 may be adhered to the second sheet-like conductor 30 with, for example, a tape.

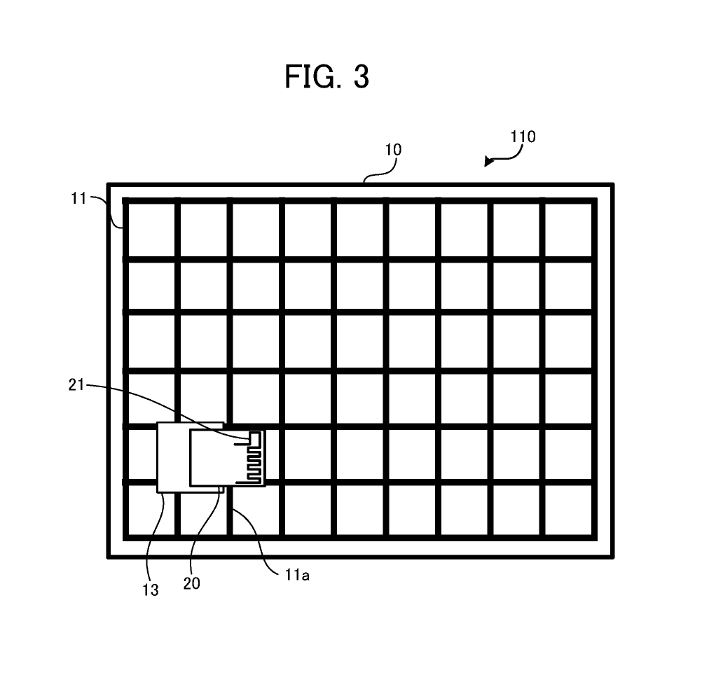

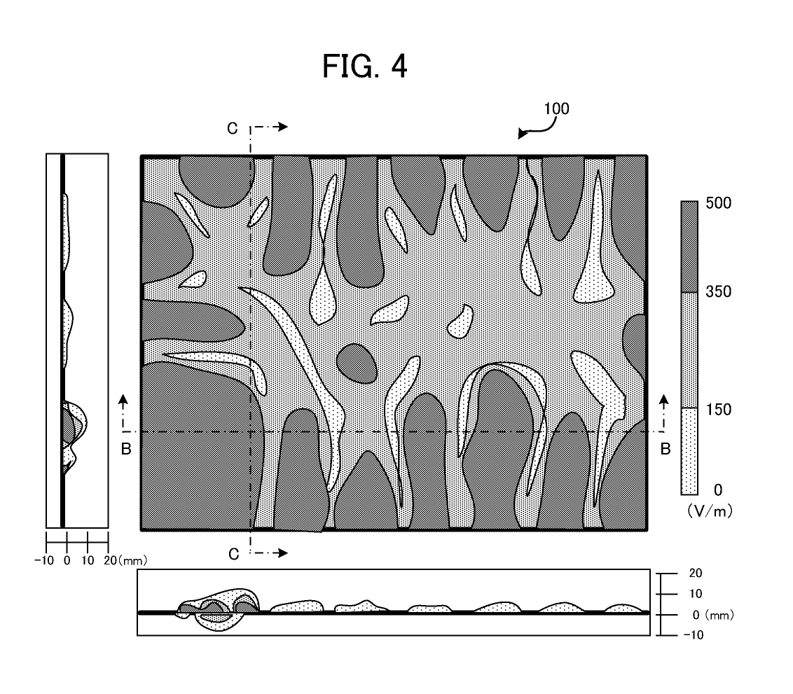

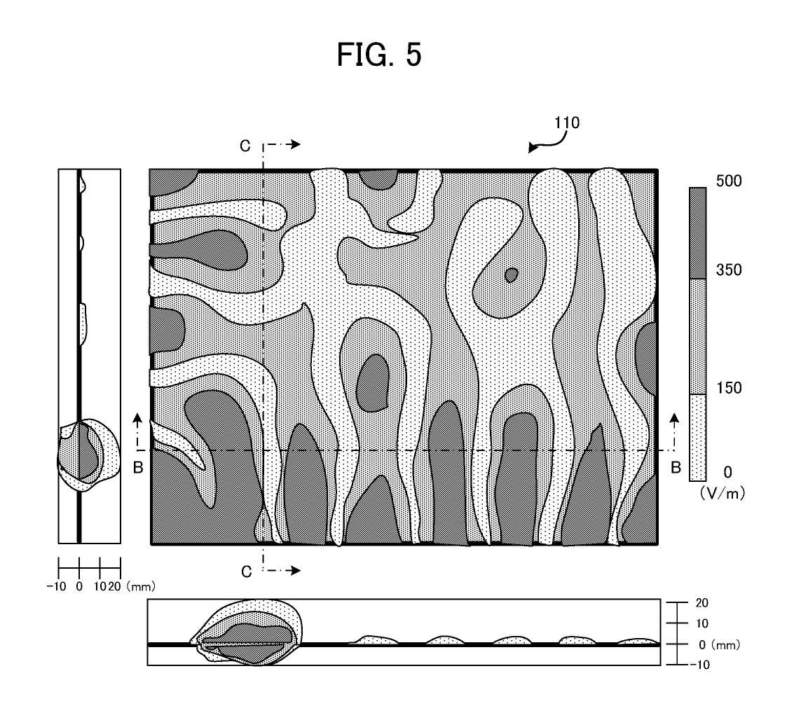

The configuration of the communication sheet 100 has been described above with reference to FIGS. 1A, 1B, 1C and 2. The following describes a difference in electric field intensity distribution with reference to a comparative example. FIG. 3 is a top plan view of the communication sheet 110 according to the comparative example. As shown in FIG. 3, the wireless board 20 mounted on the major surface of the first sheet-like conductor 10 has the meander line 21 and the linear conductor 11a disposed in parallel in the same direction (direction in which the current direction and the wiring direction are the same), not overlapping with each other. The difference in electric field intensity distribution in this case is shown in FIGS. 4 and 5. FIG. 4 shows the electric field strength distribution of the communication sheet 100 according to the embodiment of FIG. 1A, and FIG. 5 shows the electric field strength distribution of the communication sheet 110 according to the comparative example of FIG. 3. FIGS. 4 and 5 each show, in addition to a plan view showing the electric field intensity distribution, a cross-sectional view along line B-B (lower figure) showing the electric field intensity distribution and a cross-sectional view along line C-C (left figure). The electric field intensity (V/m) becomes stronger as the color gets darker.

It may be seen from the plan views of FIG. 4 and FIG. 5 that the communication sheet 100 has stronger leaking waves on the sheet surface than the communication sheet 110. In the communication sheet 110 of FIG. 5, radio waves are attenuated at the upper right apart from the mounting place of the wireless board 20. The electric field intensity was measured at four apexes of the full opening to obtain an average, which was quantitatively 335.4 (V/m) in FIGS. 4 and 261.1 (V/m) in FIG. 5. Therefore, it is understood that the electric field strength of the communication sheet 100 is about 30% higher than that of the communication sheet 110.

Also, from the left figure and the lower figure, it may be seen that the radiation of the radio waves to the space is reduced more in the communication sheet 100 than in the communication sheet 110. In particular, in the case of the communication sheet 110, it may be seen that radio waves are radiated from the through hole 90 despite the fact that the metal tape 40 is adhered. It is understood from these facts that when the meander line 21 is superimposed on the linear conductor 11a, both are strongly coupled. However, as may be seen from the electric field strength distribution of the communication sheet 110 in FIG. 5, when the meander line 21 and the linear conductor 11a are not parallel to each other even if they do not overlap with each other, the electric wave propagates in the communication sheet 110. Therefore, overlapping itself is not essential.

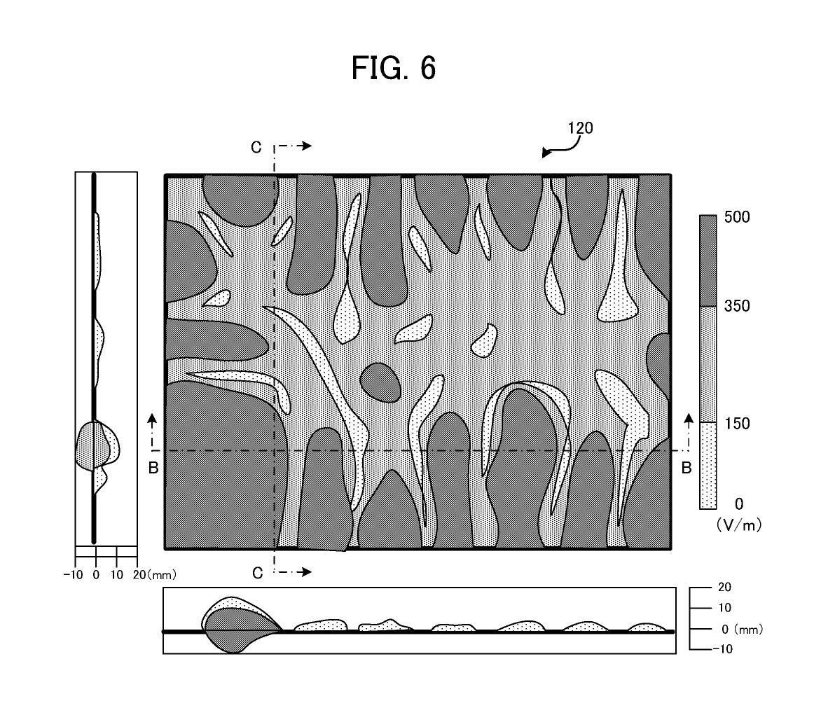

Next, with reference to FIG. 6, an electric field strength distribution which varies depending on the presence or absence of a metal tape will be described. FIG. 6 is a diagram showing the electric field intensity distribution of a communication sheet 120 without the metal tape 40. The communication sheet 120 differs from the communication sheet 100 in that there is no metal tape 40.

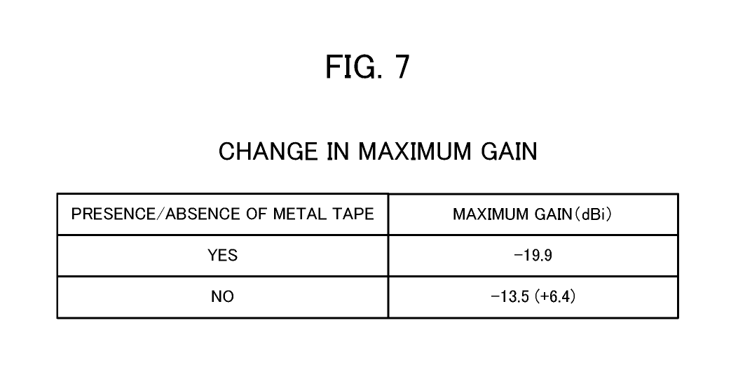

Referring to FIG. 6, the electric field intensity distribution on the plane of the communication sheet 120 is the same as the electric field intensity distribution of the communication sheet 100 in FIG. 4. On the other hand, referring to the lower figure and the left figure, it may be seen that the absence of the metal tape 40 in the communication sheet 120 permits the radio waves to be radiated in the downward space. The change in the maximum gain in the presence or absence of the metal tape is shown in FIG. 7. As shown in the figure, the communication sheet 100 with the metal tape 40 has a smaller gain than the communication sheet 120 without the metal tape 40. In two-dimensional communication, it is preferable that radio waves should not be radiated in space, so that the smaller the gain, the better the communication. Therefore, when the metal tape 40 is not present, the gain is 6.4 dBi higher, so that more radio waves are radiated to the space accordingly. However, since it is possible to infiltrate radio waves in the near field without the metal tape 40, it is not essential to adhere the metal tape 40 itself

As described above, the communication sheet 100 in this embodiment includes the wireless board 20 having the meander line 21 parallel to one of the plurality of intersecting linear conductors 11. For this reason, due to the electromagnetic field coupling between the meander line 21 and the linear conductor 11a, radio waves propagate from the linear conductor 11a into the communication sheet 100, and radio waves leach from the plurality of openings to the near field.

Therefore, it is unnecessary to modify the wireless board 20 for combining with the communication sheet 100, and a dedicated connector for connecting the wireless board 20 and the communication sheet 100 is unnecessary. In addition, if the wireless board 20 is mounted on the major surface of the first sheet-like conductor 10 so that the direction of the current in the meander line 21 and the wiring direction of the linear conductor 11a are the same, radio waves propagate evenly in the communication sheet 100 even if the meander line 21 and the linear conductor 11a do not overlap with each other (see FIG. 5). Therefore, the communication sheet 100 according to this embodiment may permit radio waves to be uniformly leached on the sheet surface with a reduced number of man-hours and the expense.

In addition, the communication sheet 100 according to this embodiment includes (a through hole 90 including) the removal hole 13 from which the region including the other linear conductors 11b to 11d except the linear conductor 11a is removed. Therefore, the coupling force of the electromagnetic field coupling between the meander line 21 and the linear conductor 11a may be increased, which may increase the propagation efficiency of radio waves.

In the communication sheet 100 according to this embodiment, the wireless board 20 is mounted on the major surface of the first sheet-like conductor 10 so that the center line 23 of the meander line 21 and the linear conductor 11a substantially overlap with each other. Generally, the wider the overlapping area is, the higher the coupling force of electromagnetic field coupling gets. Therefore, compared to the case where they do not overlap with each other, the meander line 21 and the linear conductor 11a may be strongly coupled to each other. For this reason, electric field strength may be increased (see FIG. 4) in addition to uniform leaching of radio waves. Therefore, a communication device (for example, a smartphone or the like) may reliably receive radio waves on the surface of the communication sheet 100.

In addition, the communication sheet 100 according to this embodiment is provided with a through hole 90 penetrating the dielectric 60 and a second sheet-like conductor 30 directly underlying the removal hole 13. It is difficult and expensive to form only the removal hole 13 of the first sheet-like conductor 10, that is, to leave only the dielectric 60 and the second sheet-like conductor 30 as compared with the case of forming the through hole 90. Therefore, provision of the through hole 90 may suppress the cost as compared with the case where only the removal hole 13 is formed.

The communication sheet 100 according to this embodiment includes a metal tape 40 that covers at least the opening portion of the through hole 90 that faces the meander line 21 from the second sheet-like conductor 30 side. Therefore, the metal tape 40 may be used with the same function as the second sheet-like conductor 30. Therefore, it is possible to prevent radio wave leakage from the through hole 90.

In addition, the communication sheet 100 according to this embodiment includes the sheet-like battery 50 that supplies power to the wireless board 20. For this reason, two-dimensional communication may be carried out in an apparently completely cableless manner. In addition, the sheet-like battery 50 is suitable for combination with the communication sheet 100, which does not make the communication sheet 100 larger. However, in the case where the routing of the conducting wire 51 becomes complicated (for example, in the case where the terminal of the wireless board 20 is not on the same surface as the sheet-like battery 50 but on the opposite surface), a button battery or the like may be substituted as appropriate.

The effect of the communication sheet 100 according to this embodiment has been described above. The communication sheet 100 may be used for various purposes by cooperating with a communication device (for example, a smartphone or the like). A conceivable use case, for example, is that the communication sheet 100 cooperates with an application of a smartphone. An application that cooperates with a signal (unique identification information) that the wireless board 20 (beacon) transmits is installed in the smartphone beforehand. Now, it is assumed that the user places the smartphone on the surface of the communication sheet 100. Then, the application of the smartphone triggers the reception of the signal to activate the application.

For example, as a conceivable use case, when a student places a smartphone on the communication sheet 100 laid on each desk in the classroom, so that an attendance notice is automatically made to the teacher's portable terminal (for example, a tablet terminal) by an attendance notification application. Alternatively, as another conceivable use case, when a visiting customer places a smartphone on the communication sheet 100 laid on each table in a restaurant, so that a menu is automatically opened by a menu application.

Although the above completes the description of the embodiment, the above-described embodiment is merely an example, and it is needless to say that the configuration of the communication sheet 100 is not limited to the one given in the above description of the embodiment.

### Modification 1

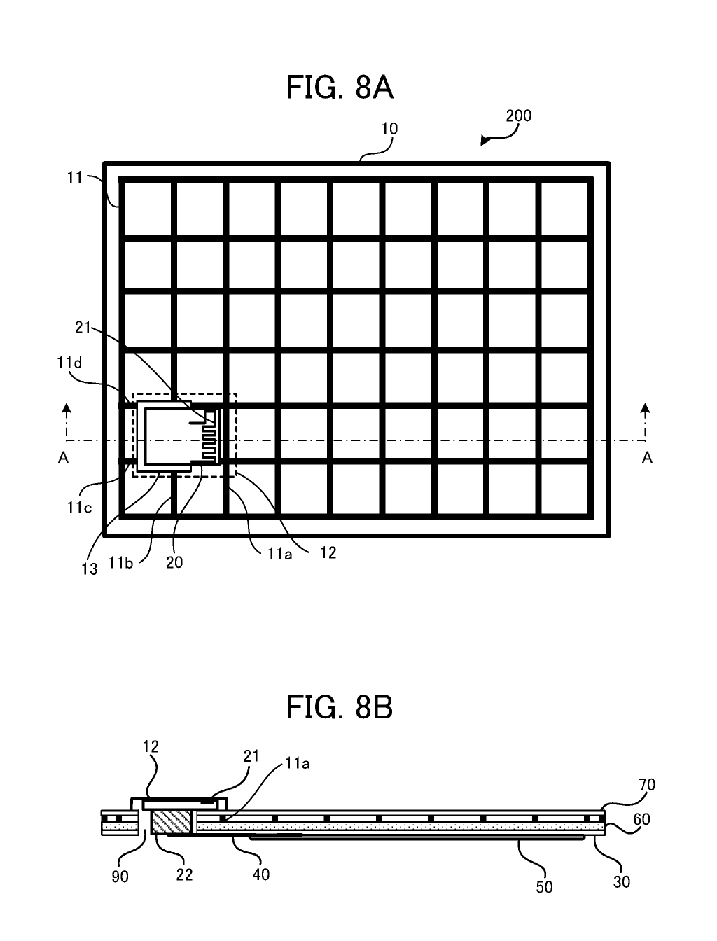

The embodiment has been described above referring to the case where the meander line 21 and the linear conductor 11a overlap with each other as an example, but is not limited to such a case. For example, as shown in FIGS. 8A and 8B, the meander line 21 and the linear conductor 11a may be close to each other. That is, the wireless board 20 is disposed on the major surface of the first sheet-like conductor 10 in such a way that the direction of the current of the meander line 21 is the same as the direction of the linear conductor 11a, and the meander line 21 and the linear conductor 11a are close to each other. This communication sheet 200 differs from the communication sheet 100 in that the meander line 21 and the linear conductor 11a are close to, not overlapping, each other.

In the case of the meander line 21, the radiating portion (the thick line portion in FIG. 2) is preferably close to the linear conductor 11a. This range of proximity is a range in which electromagnetic field coupling is possible. For example, the distance from the radiating portion of the meander line 21 to the linear conductor 11a may be 1 mm. Also in the communication sheet 200 of Modification 1, it is possible to cause the radio wave to uniformly leach on the surface of the communication sheet 200. Therefore, it is possible to provide the communication sheet 200 which can sufficiently withstand practical use.

### Modification 2

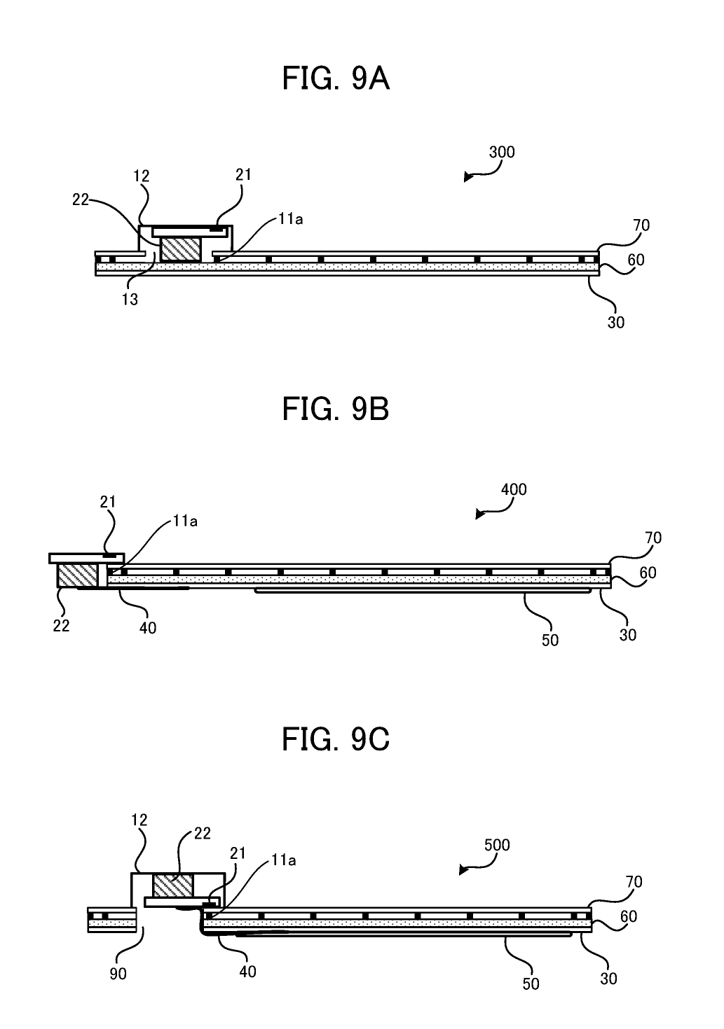

Although it is assumed for the embodiment described above that there is the through hole 90 in the communication sheet 100, the present disclosure is not limited to the case. FIG. 9A is a cross-sectional view of a communication sheet 300 according to Modification 2. This communication sheet 300 differs from the communication sheet 100 in that it has only the removal hole 13 in place of the through hole 90.

According to the communication sheet 300, which does not need the metal tape 40, the number of parts may be reduced in addition to the above-described effect of the communication sheet 100. Further, since the wireless board 20 is confined in the space between the fixing member 12 and the dielectric 60, it is not possible to supply power through the conducting wire 51 using the sheet-like battery 50. Therefore, the button battery may be directly attached to the wireless board 20 to supply power. This eliminates the need for routing the conducting wire 51.

### Modification 3

The mounting position of the wireless board 20 is not limited to that of the above-described embodiment. For example, the mounting position of the wireless board 20 may be the position of a communication sheet 400 according to Modification 3 of FIG. 9B. In this Modification 3, the wireless board 20 is mounted on the major surface near the edge of the first sheet-like conductor 10. In this case, the linear conductor 11a is the outer linear conductor located on the outermost side. According to this communication sheet 400, it is not necessary to provide holes (removal hole 13 and through hole 90), so that in addition to the above-described effect of the communication sheet 100, there is an effect of reducing the number of man-hours and the cost.

### Modification 4

Although it is assumed for the embodiment described above that the meander line 21 and the linear conductor 11a overlap with each other with a gap therebetween, the present disclosure is not limited to the case. In order to increase the coupling force of the electromagnetic field coupling, it is preferable that the distance is short. For this reason, in a communication sheet 500 according to Modification 4 of FIG. 9C, the wireless board 20 is set upside down in order to narrow the distance between the meander line 21 and the linear conductor 11a. The wireless board 20 is fixed by bonding the wireless board 20 (chip 22) to the ceiling surface of the fixing member 12 as in the embodiment.

In the communication sheet 500 according to Modification 4, the meander line 21 and the linear conductor 11a sandwich the protective film 70 (insulating layer) of PET. However, the thickness of the protective film 70 is almost negligible. Therefore, the distance between the meander line 21 and the linear conductor 11a is very close. However, when the meander line 21 and the linear conductor 11a are physically brought into direct contact, the characteristics change. Therefore, it is necessary to sandwich the insulating layer between the meander line 21 and the linear conductor 11a. In this respect, since the thickness of the protective film 70 is very thin, it is suitable as an insulating layer. The communication sheet 500 according to Modification 4 has the wireless board 20 turned upside down, so that the gap between the meander line 21 and the linear conductor 11a may be narrowed and strongly coupled. Since the coupling force may be increased, an effect of further strengthening the electric field strength may be obtained in addition to the effect of the communication sheet 100.

### Modification 5

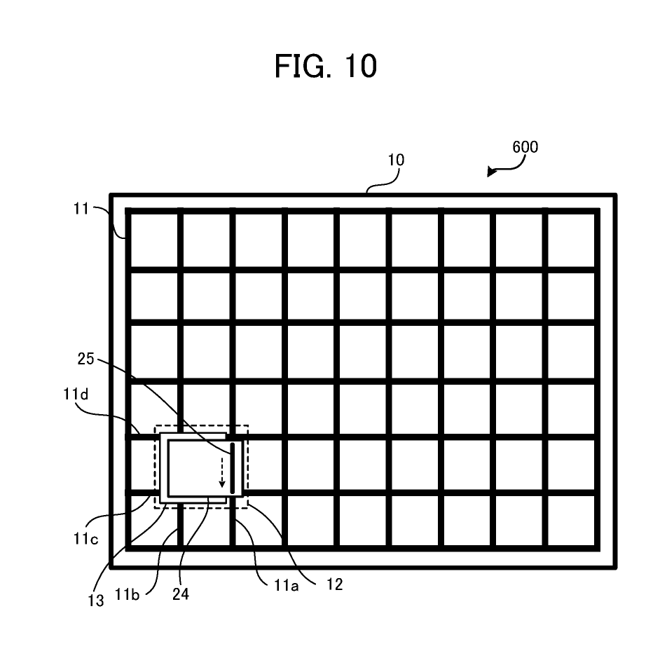

Although it is assumed for the embodiment described above that the meander line 21 is used as the linear antenna, the present disclosure is not limited to this case. For example, the linear antenna pattern 25 shown in FIG. 10 may be used as the linear antenna. In a communication sheet 600 according to Modification 5, the wireless board 24 is mounted on the major surface of the first sheet-like conductor 10 so that the antenna pattern 25 and the linear conductor 11a substantially overlap with each other. At this time, like the meander line 21, the direction of the current flowing through the antenna pattern 25 (the broken line arrow in the drawing) and the wiring direction of the linear conductor 11a are made to be the same. The communication sheet 600 of Modification 5 may provide the same effect as that of the communication sheet 100. Although the linear antenna may take various antenna patterns, it is sufficient that the direction of the current and the wiring direction are aligned to overlap with each other.

In the above-described embodiment and Modifications 1 to 5, the first sheet-like conductor 10 has been described on the premise that the first sheet-like conductor 10 has a lattice shape having a plurality of openings defined by a plurality of intersecting linear conductors 11, the lattice shape is not restrictive. It is not necessary for the plurality of linear conductors 11 to be orthogonal to one another in the vertical and horizontal directions (that is, the openings are rectangular), and it is sufficient if they cross one another. That is, the first sheet-like conductor may have a plurality of openings defined by a plurality of intersecting linear conductors 11. For this reason, the openings may have any angular shape, for example, a first sheet-like conductor having a plurality of triangular openings may be used. In short, it suffices that one linear conductor of the plurality of linear conductors 11 and the linear antenna are parallel and the shape of the opening is not limited.

Further, as long as the linear antenna of the wireless board 20 and one linear conductor are parallel (that is, the current direction and the wiring direction are aligned and in parallel), the mounting position of the wireless board 20 is set to the first of the major surface of the sheet-like conductor 10. That is, any one of the plurality of linear conductors 11 functions as the linear conductor 11a in the embodiment. Although the mounting orientation is horizontal in the embodiment, the mounting orientation may be vertical. In other words, positioning is optional as long as it is parallel. Therefore, it is possible for the designer to appropriately determine the mounting position of the wireless board 20, such as the middle or the end on the major surface of the first sheet-like conductor 10, enhancing the degree of freedom of design.

Further, although the metal tape 40 is used as an example in the above-described embodiment, the present disclosure is not limited to the case. As with the second sheet-like conductor 30, a material that functions as a shield may be adopted. For example, a thin metal plate may be used instead of the metal tape 40. In this case, the second sheet-like conductor 30 and the chip 22 may be adhered by applying an adhesive material to the metal plate.

Although the first and second sheet-like conductors 10 and 30 have been described to be made of aluminum as an example in the above-described embodiment, the material is not restrictive. For example, the first and second sheet-like conductors 10 and 30 may be made of a conductor such as copper, silver, nickel or the like. Further, the dielectric 60 is not limited to foamed polyolefin, and may be made of other kinds of materials (such as polyester, polyamide, and aromatic polyamide), and an insulator (for example, glass epoxy material) may also be used. Further, the dielectric 60 may be formed of a fibrous structure such as a woven fabric, a knitted fabric, a wet type nonwoven fabric, a dry type nonwoven fabric or the like. The dielectric 60 may also be air.

Further, the relative dielectric constant of the dielectric 60 at a frequency of 800 MHz to 10 GHz is 1.0 to 15, preferably 1.0 to 5.0, or preferably 1.0 to 3.0. In addition, the dielectric 60 may be made of a material such as olefin resin (TPO), styrene resin (SBC), vinyl chloride resin (TPVC), urethane resin (PU), ester resin (TPE), amide resin (TPAE), fluorinated resin (PTFE), an epoxy resin, a phenol resin, a polyphenylene ether resin, or the like.

In particular, considering the relative permittivity and workability, the dielectric 60 is preferably made of polyolefin such as polyethylene (PE) or polypropylene (PP), polyester such as polyethylene terephthalate (PET), polyethylene naphthalate (PEN), polybutylene terephthalate (PBT), or trimethylene terephthalate (PTT), or polyimide (PI), and polyester and polyolefin are particularly preferable.

In addition, the dielectric 60 is preferably a porous material; for example, foamed polyethylene, foamed polypropylene or the like having a porosity of 50 to 85% is preferable. Since the dielectric 60 is made of a porous material, the porosity of the sheet is increased and the relative dielectric constant approaches 1, so that stable communication performance may be obtained. As long as a porous material is used, either continuous foaming or independent foaming is acceptable.

Further, in the above embodiment, the description has been made on the premise that power supply to the wireless board 20 is achieved by the sheet-like battery 50, which in turn is not restrictive. For example, instead of the sheet-like battery 50, a button battery or an external power supply may be used.

The following specifically describes use examples of the communication sheet 100.

### Use Example 1

The description of Use Example 1 will be given of an example of using the communication sheet 100 as a guide of an aquarium, an art museum, a museum, or the like, i.e., an example of using the communication sheet 100 as a guidance system in the hall will be described.

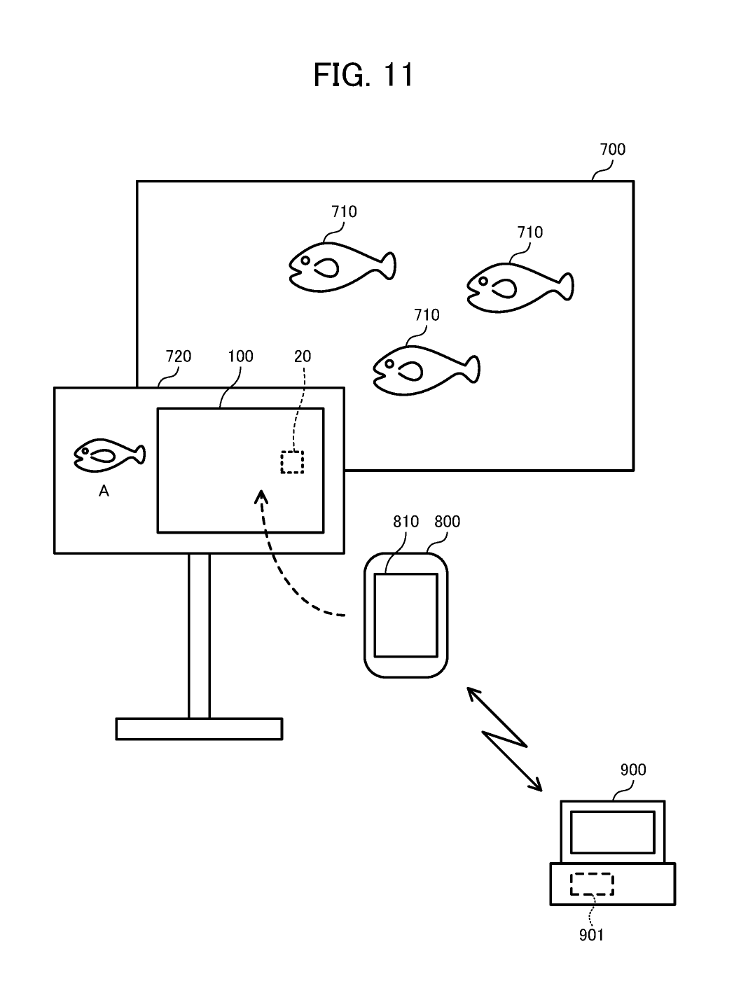

FIG. 11 shows an example in which a signboard 720 is placed in front of a water tank 700 in an aquarium. The water tank 700 is a container for containing water to rear fishes 710. The fishes 710 are ornamental fishes, which are named A. The signboard 720 presents an explanation of the fish 710 in the water tank 700. A communication sheet 100 is disposed on the surface of the signboard 720. A terminal device 800 is what is carried by an aquarium visitor. A server 900 is what is owned by the entity that operates the aquarium. A storage device 901 stores various kinds of information, and is, for example, a hard disk. Although an example in which the storage device 901 is built in the server 900 will be described herein, the storage device 901 may be provided outside the server 900.

The communication sheet 100 transmits a beacon signal including guidance specifying information for specifying guidance information on the fish 710, and identification information of the communication sheet 100 from the top surface (the surface of the two surfaces which lies farther from the signboard 720). Strictly speaking, while the wireless board 20 of the communication sheet 100 transmits a beacon signal, it will be referred to as appropriate that the communication sheet 100 transmits a beacon signal. For example, the beacon signal transmitted from the communication sheet 100 propagates within a range of several centimeters from the surface of the communication sheet 100. Note that this distance may be adjusted by the intensity of the radio waves transmitted by the wireless board 20. This guidance information is used to explain the fish 710, and is image information and voice information.

The guidance specifying information may be any information as long as it can specify the guidance information. The guidance specifying information may be, for example, identification information of the fish 710, identification information of the communication sheet 100, a URL (Uniform Resource Locator) in which guidance information is stored, an address on the storage device 901 at which the guidance information is stored, and the guidance information. It is assumed that the guidance specifying information and the guidance information are associated and stored in the terminal device 800, the server 900, the storage device 901, and the like. In this case, the terminal device 800 may obtain the guidance information from the guidance specifying information included in the beacon signal by accessing the server 900 and the storage device 901 as appropriate.

For example, it is assumed that the guidance specifying information is the identification information of the fish 710, and information associating the guidance specifying information with the guidance information is stored in the storage device 901.

In this case, the terminal device 800 transmits the guidance specifying information included in the beacon signal to the server 900. On the other hand, the server 900 acquires guidance information (guidance information of the fish 710) associated with the received guidance specifying information (identification information of the fish 710) from the storage device 901, and transmits the guidance information to the terminal device 800. Then, the terminal device 800 receives the guidance information from the server 900.

The terminal device 800 is a smartphone capable of receiving a beacon signal of the 2.4 GHz band conforming to, for example, Bluetooth (registered trademark) Low Energy (BLE). The terminal device 800 includes a touch screen 810 that may display image information and may accept operations from the user. The terminal device 800 includes an non-illustrated CPU (Central Processing Unit), an non-illustrated ROM (Read Only Memory), an non-illustrated RAM (Random Access Memory), a communication interface (not shown), and a speaker. This communication interface has a function of receiving a beacon signal and a function of wirelessly communicating with the server 900. The CPU of the terminal device 800 controls the display of the touch screen 810 or controls the communication by the communication interface according to a program stored in the ROM, for example.

When a visitor wants to know detailed information on the fish 710, the visitor brings the terminal device 800 closer to the communication sheet 100 disposed on the signboard 720. Then, the terminal device 800 receives the beacon signal transmitted from the communication sheet 100, displays an image based on the guidance information specified by the guidance specifying information included in the beacon signal, outputs a sound based on the guidance information. Upon receiving the beacon signal from the communication sheet 100, the terminal device 800 transmits the identification information of the communication sheet 100 and the identification information of the terminal device 800 to the server 900.

The server 900 wirelessly communicates with the terminal device 800 over a network (not shown). The server 900 includes an non-illustrated CPU, an non-illustrated ROM, an non-illustrated RAM, an non-illustrated hard disk, an non-illustrated RTC (Real Time Clock), and an non-illustrated communication interface. Upon receiving the identification information of the communication sheet 100 and the identification information of the terminal device 800 from the terminal device 800, the server 900 associates as history information the identification information of the communication sheet 100, the identification information of the terminal device 800, and the reception time information indicating the reception time with one another, and stores the history information in the storage device 901.

Here, position information indicating the position where the communication sheet 100 is disposed is stored in the storage device 901 in advance. Further, the communication sheet 100 is mounted in correspondence to the water tank 700 or the fish 710. Therefore, the position information may also be said to be information for specifying the water tank 700 or the fish 710. In this case, for example, information that associates the identification information of the communication sheet 100, the position information of the communication sheet 100, the identification information of the water tank 700, and the identification information of the fish 710 with one another may be stored in the storage device 901. When there are a plurality of communication sheets 100, the storage device 901 may store the position information indicating the position where each of the plurality of communication sheets 100 is disposed. In this case, the position information is information indicating the correspondence between the identification information of the communication sheet 100 and the position of the communication sheet 100 for each of the plurality of communication sheets 100.

The history information stored in the storage device 901 of the server 900 may be applied to various processes. For example, it is assumed that a visitor owning the terminal device 800 brings the terminal device 800 closer to the communication sheet 100 in front of the water tank 700 at a first time, a second time, and a third time. In this case, first history information in which the identification information of the communication sheet 100, the identification information of the terminal device 800 and the first time are associated with one another, second history information in which the identification information of the communication sheet 100, the identification information of the terminal device 800 and the second time are associated with one another, and third history information in which the identification information of the communication sheet 100, the identification information of the terminal device 800 and the third time are associated with one another are stored in the hard disk provided in the server 900. In this case, on the basis of the first to third history information and the position information, the server 900 may specify at which time the visitor owning the terminal device 800 has observed the water tank 700.

For example, it is assumed that the server 900 provides a raising game such that each time the water tank 700 is visited on a different day, the fish 710 raised in the water tank 700 grows by one step. In this case, the server 900 may control the raising game so that the fish 710 grows by one step every time a visitor visits the water tank 700 on a different day and brings the terminal device 800 closer to the communication sheet 100. Alternatively, the server 900 may supply more detailed information on the fish 710 to the terminal device 800 in stages, for example, every time the water tank 700 is visited on a different day.

It is also assumed that a plurality of water tanks 700 (for example, a first water tank, a second water tank, and a third water tank) provided in the aquarium are respectively provided with communication sheets 100 (for example, a first communication sheet, a second communication sheet, and a third communication sheet) are provided. It is further assumed that a visitor owning the terminal device 800 brings the terminal device 800 closer to the first communication sheet in front of the first water tank at the first time, brings the terminal device 800 closer to the second communication sheet in front of the second water tank at the second time, and brings the terminal device 800 closer to the third communication sheet in front of the third water tank at the third time.

In this case, the first history information in which the identification information of the first communication sheet, the identification information of the terminal device 800 and the first time are associated with one another, the second history information in which the identification information of the second communication sheet, the identification information of the terminal device 800 and the second time are associated with one another, and the third history information in which the identification information of the third communication sheet, the identification information of the terminal device 800 and the third time are associated with one another are stored in the storage device 901. In this case, the server 900 may specify the flow line of the visitor owning the terminal device 800 based on the first to third history information and the position information. Specifically, the server 900 may consider that the visitor who owns the terminal device 800 has made observation in the order of the first water tank, the second water tank, and the third water tank. The server 900 may appropriately display image information indicating the flow line of a visitor on a display unit (not shown) or transmit the image information to another device (for example, the terminal device 800).

As described above, Use Example 1 is applied to the communication system including the communication sheet 100 and the terminal device 800. The communication sheet 100 transmits a beacon signal including guidance information of an exhibit placed near the communication sheet 100. When receiving the beacon signal in proximity to the communication sheet 100, the terminal device 800 outputs an image or sound based on the guidance information.

Further, in Use Example 1, a plurality of communication sheets 100 may be provided, and a server 900 and a storage device 901 may be further provided. In this case, each of the plurality of communication sheets 100 transmits a beacon signal including guidance information of an exhibit placed near the local communication sheet and identification information of the local communication sheet. Further, in the storage device 901, position information indicating the position where each of the plurality of communication sheets 100 is disposed is stored. Upon receiving the beacon signal, the terminal device 800 transmits the identification information of the communication sheet 100 that has transmitted the beacon signal and the identification information of the terminal device 800 to the server 900. On the other hand, upon receiving the identification information of the communication sheet 100 from which the beacon signal has been transmitted from the terminal device 800 and the identification information of the terminal device 800, the server 900 transmits the identification information of the communication sheet 100 that has transmitted the beacon signal and the identification information of the terminal device 800 and stores the history information in which the identification information and the time information indicating the reception time are associated with one another in the storage device 901. Then, based on the history information and the position information, the server 900 outputs information indicating the route along which the terminal device 800 has moved.

Further, in Use Example 1, a plurality of communication sheets 100 associated with different fishes may be provided on one signboard 720. Even in such a case, an area where a beacon signal transmitted by a certain communication sheet 100 (referred to as “first communication sheet”) reaches and an area where a beacon signal transmitted by another communication sheet 100 (“second communication sheet”) basically do not overlap with each other. Therefore, interference of a plurality of beacon signals with one another and reception of a beacon signal by an unintended terminal device 800 may be suppressed. For example, it is possible to suppress that the terminal device 800 disposed on the second communication sheet receives the beacon signal transmitted by the first communication sheet.

In Use Example 1, the communication sheet 100 is used in which a beacon signal propagates only in the vicinity of one surface of the communication sheet 100, not in a conventional communication device in which a beacon signal propagates in a three-dimensional space. Therefore, in Use Example 1, it is not likely that the beacon signal is erroneously transmitted to the terminal device 800 located away from the communication sheet 100. Therefore, according to Use Example 1, it is possible to provide the information included in the beacon signal only to the necessary visitors. Further, according to Use Example 1, it is possible to accurately specify the position of a visitor (the position of the terminal device 800). Further, in Use Example 1, a beacon signal may be supplied to a plurality of terminal devices 800 at the same time.

In Use Example 1, an example in which the exhibit is the fishes 710 (or the water tank 700) has been described. Exhibits may be paintings at art museums or exhibits at museums.

### Use Example 2

The description of Use Example 1 has been given of an example in which the communication sheet 100 including the wireless board 20 is used as a single body. The description of Use Example 2 will be given of an example using a wireless board 20A, a wireless board 20B, and a wireless board 20C in addition to the communication sheet 100 including the wireless board 20. Basically, the wireless boards 20A to 20C have the same configuration as the wireless board 20, except that they are not fixed to the communication sheet 100. The description of Use Example 2 will be given of an example in which the wireless board 20A, the wireless board 20B, the wireless board 20C, and the communication sheet 100 are used as a guidance system in a hall.

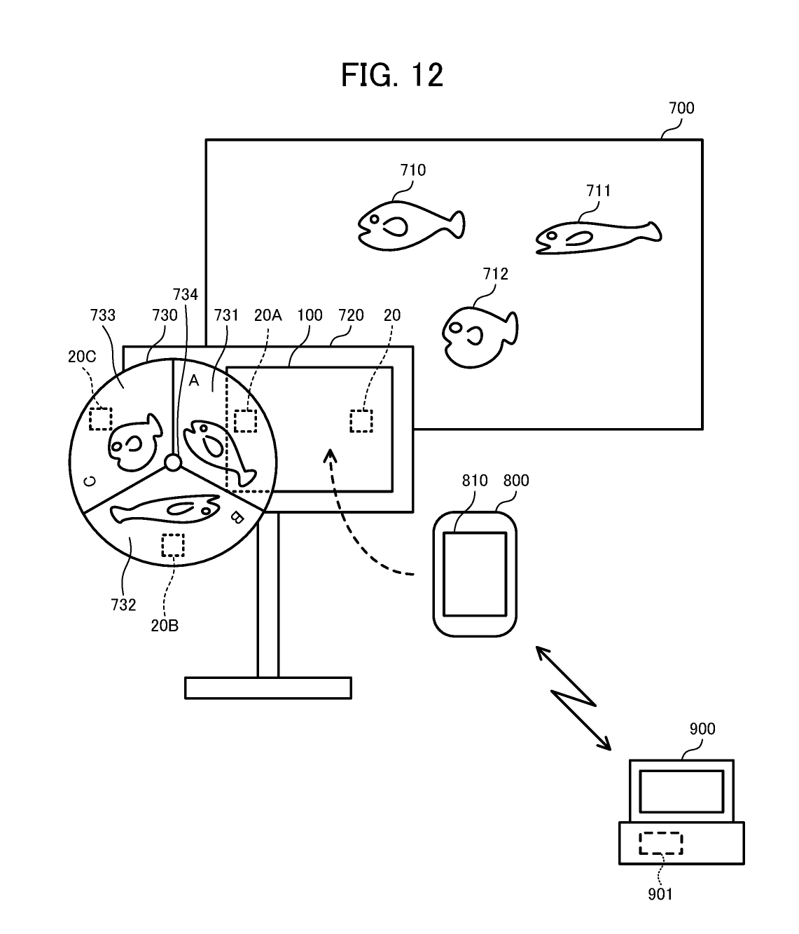

As shown in FIG. 12, it is assumed that fish 710, fish 711, and fish 712 are kept in water tank 700. Here, fish 710, fish 711, and fish 712 are different types of fish.

The fish 710 is named A, the fish 711 is named B, and the fish 712 is named C. A rotating member 730 is rotatably attached to the signboard 720.

The rotating member 730 receives a rotating operation for selecting one type of fish from three types of fish A, B and C. The rotating member 730 is a thin cylindrical member that rotates about s rotating shaft 734. The rotating member 730 is divided into three regions (region 731, region 732, and region 733) when viewed from a direction orthogonal to the bottom surface.

The regions 731, 732, and 733 are associated with the fish 710, the fish 711, and the fish 712, respectively. On one side (the front side in the figure) of the rotating member 730, the picture and the name of the fish 710 are drawn in the region 731, the picture and the name of the fish 711 are drawn in the region 732, the picture and the name of the fish 712 are drawn. Further, on the other surface (the surface on the far side in the figure) of the rotating member 730, the wireless board 20A is adhered to the region 731, the wireless board 20B is adhered to the region 732, and the wireless board 20C is adhered to the region 733.

The wireless board 20 transmits a beacon signal including identification information of the communication sheet 100 and message information prompting selection of fish. The wireless board 20A transmits a beacon signal including guidance specifying information for identifying guidance information on the fish 710 and identification information on the fish 710. The wireless board 20B transmits a beacon signal including guidance specifying information for specifying the guidance information on the fish 711 and identification information on the fish 711. The wireless board 20C transmits a beacon signal including guidance specifying information for specifying the guidance information on the fish 712 and identification information on the fish 712.

Here, only one of the wireless board 20A, the wireless board 20B, and the wireless board 20C is disposed so as to be close to the surface of the communication sheet 100. That is, the visitor rotates the rotating member 730 so that a desired one of the region 731, the region 732, and the region 733 overlaps with the communication sheet 100. Then, a beacon signal transmitted from a wireless board (hereinafter, appropriately referred to as “selected wireless board”) adhered to an area overlapping with the communication sheet 100 propagates within the communication sheet 100. Note that the beacon signal transmitted from the wireless board 20 always propagates within the communication sheet 100.

Here, when the visitor brings the terminal device 800 closer to the communication sheet 100, the terminal device 800 receives the beacon signal transmitted from the wireless board 20 and the beacon signal transmitted from the selected wireless board. Then, based on the message information included in the beacon signal transmitted from the wireless board 20, the terminal device 800 displays a message prompting selection of a fish or outputs a voice. Further, the terminal device 800 displays an image based on the guidance information specified by the guidance specifying information included in the beacon signal transmitted from the selected wireless board, and outputs the sound based on the guidance information. Further, the terminal device 800 transmits the identification information of the communication sheet 100, the identification information of the selected fish, and the identification information of the terminal device 800 to the server 900.

Upon receiving the identification information of the communication sheet 100, the identification information of the selected fish, and the identification information of the terminal device 800 from the terminal device 800, the server 900 stores, in the storage device 901, history information that associates the identification information of the communication sheet 100, the identification information of the selected fish, the identification information of the terminal device 800, and the reception time information with one another. Based on the history information and the position information stored in the storage device 901, the server 900 may specify the time when the visitor has visited the water tank 700, the type of the fish the visitor is interested in, and so forth. Therefore, the server 900 may grow the fish according to the number of visitors in the fish raising game and present information indicating the flow lines of the visitors in the fish raising game as in Use Example 1.

As described above, Use Example 2 is applied to a communication system including a plurality of communication devices (wireless boards 20A to 20C), a communication sheet 100, a terminal device 800, and a support member (signboard 720, rotating member 730). A plurality of communication devices (wireless boards 20A to 20C) are provided so that one of the plurality of communication devices (wireless boards 20A to 20C) is disposed at a position close to the communication sheet 100 as a selected communication device. In addition, each of the plurality of communication devices (wireless boards 20A to 20C) transmits a beacon signal including guidance information of an exhibit associated with the local communication device. Then, the communication sheet 100 propagates a beacon signal transmitted by the selected communication device. Upon receiving the beacon signal in proximity to the communication sheet 100, the terminal device 800 outputs an image or a sound based on the guidance information of the exhibit associated with the selected communication device.

Use Example 2 also provides the same effect as in Use Example 1. Furthermore, with Use Example 2, it is possible to select a wireless board that transmits a beacon signal propagating through the communication sheet 100. Therefore, according to Use Example 2, it is possible for a visitor to select the information to be supplied to the visitor.

### Use Example 3

Use Example 3 describes an example in which the communication sheet 100 is used for a route guidance system for guiding a user in an indoor commercial facility or a subway station.

In Use Example 3, as in Use Example 1, there is a system configuration including a communication sheet 100, a terminal device 800, and a server 900 incorporated in a signboard 720. In Use Example 3, the beacon signal transmitted from the communication sheet 100 includes guidance specifying information for specifying guidance information on the road guidance and position information indicating the position where the signboard 720 is mounted. This guidance information is used for road guidance, and is image information and voice information. A surrounding map may be drawn on the surface of the signboard 720 and furthermore, it may be indicated that the position information may be acquired by moving the terminal device 800 closer.

The guidance specifying information may be any information as long as it can specify the guidance information. The guidance specifying information is, for example, the identification information of the communication sheet 100, the URL in which the guidance information is stored, the address on the storage device 901 in which the guidance information is stored, and the guidance information. It is assumed that the guidance specifying information and the guidance information are associated and stored in the terminal device 800, the server 900, the storage device 901, and so forth. In this case, the terminal device 800 may obtain the guidance information from the guidance specifying information included in the beacon signal by accessing the server 900 and the storage device 901 as appropriate.

When the user brings the terminal device 800 closer to the communication sheet 100, the terminal device 800 receives the beacon signal including the guidance specifying information and the position information from the communication sheet 100. The terminal device 800 displays on the touch screen 810 the map based on the guidance information specified by the guidance specifying information and the current position based on the position information. Alternatively, the terminal device 800 outputs a voice notifying a route to a main destination (for example, a popular shop or a nearest station) based on the guidance information specified by the guidance specifying information and the position information. Further, the terminal device 800 may provide information indicating the nearest recommended shop from the current position, or can provide usable coupons at this shop.

Further, upon receiving the beacon signal, the terminal device 800 may store the position information indicating the current position and the time information indicating the current time, and may transmit the position information and the time information to the server 900. In this case, the terminal device 800 and the server 900 may specify the flow line of the user, and may reflect the specified flow line on the way to the user.

As described above, Use Example 3 is applied to the communication system including the communication sheet 100 and the terminal device 800. The communication sheet 100 transmits a beacon signal including position information indicating a position where the communication sheet 100 is disposed. Then, upon receiving the beacon signal in proximity to the communication sheet 100, the terminal device 800 outputs an image or sound based on the position information.

In Use Example 3, the communication sheet 100 is used instead of the conventional communication device in which the beacon signal propagates in the three-dimensional space. Therefore, according to Use Example 3, it is possible to transmit map information indicating a map around the user and position information indicating the position of the user to only the terminal device 800 in the vicinity of the communication sheet 100. Also, Use Example 3 makes it possible to acquire position information even indoors or underground where GPS (Global Positioning System) signals are hard to reach. Further, with Use Example 3, the terminal device 800 can acquire position information that may specify the rank or the height. For this reason, it is possible to specify ranks and heights which are difficult to specify by the GPS based method.

### Use Example 4

The description of Use Example 3 has been given of an example in which the communication sheet 100 including the wireless board 20 is used alone. The description of Use Example 4 will be given of an example in which a wireless board 20A, a wireless board 20B, and a wireless board 20C are used in addition to the communication sheet 100 including the wireless board 20. The description of Use Example 4 will be given of an example in which the wireless board 20A, the wireless board 20B, the wireless board 20C, and the communication sheet 100 are used as a guidance system in a hall.

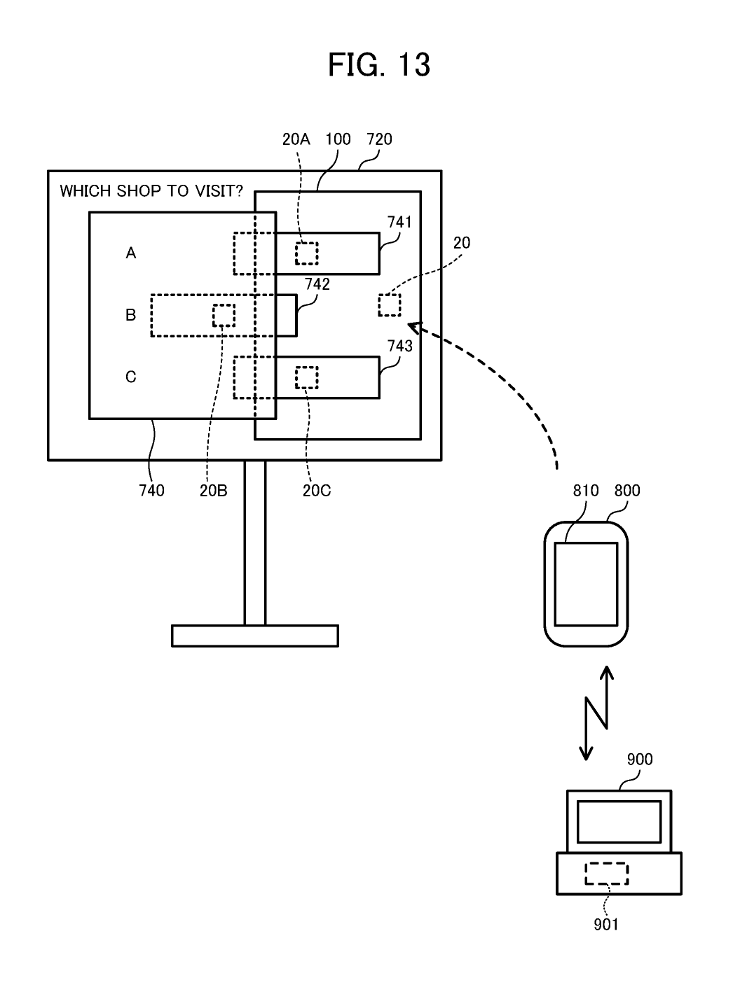

As shown in FIG. 13, in Use Example 4, the communication sheet 100 and the accommodating case 740 are disposed on the surface of the signboard 720. The accommodating case 740 accommodates a plate-like member 741, a plate-like member 742, and a plate-like member 743 in a such a manner that those members may be taken in and out. That is, the plate-like member 741 is slidable with respect to the accommodating case 740, and has a state where substantially the whole plate-like member 741 is accommodated in the accommodating case 740 (hereinafter referred to as “accommodation state”) and a state where the plate-like member 741 protrudes from the accommodating case 740 (hereinafter referred to as “non-accommodation state”). Likewise, the plate-like member 742 and the plate-like member 743 are also slidable with respect to the accommodating case 740 and each have an accommodation state and a non-accommodation state.

The wireless board 20 of the communication sheet 100 transmits a beacon signal including map specifying information, current position information, and message information prompting selection of a shop. The map specifying information is information for specifying the map information. The map specifying information and the map information are associated with each other and stored in the terminal device 800, the server 900, the storage device 901, and the like. A wireless board 20A is adhered to the bottom surface of the plate-like member 741. The wireless board 20A transmits a beacon signal including guidance specifying information for specifying guidance information on a shop named A, and destination information indicating the location of the shop named A. A wireless board 20B is attached to the bottom surface of the plate-like member 742. The wireless board 20B transmits a beacon signal including guidance specifying information for specifying guidance information on a shop named B and destination information indicating the location of the shop named B. A wireless board 20C is attached to the bottom surface of the plate-like member 743. The wireless board 20C transmits a beacon signal including guidance specifying information for specifying guidance information on a shop named C and destination information indicating the location of the shop named C.

The beacon signal transmitted from the wireless board 20 always propagates within the communication sheet 100. When the plate-like member 741 is in the accommodation state, the wireless board 20A is not disposed in the vicinity of the communication sheet 100, so the beacon signal transmitted by the wireless board 20A does not propagate in the communication sheet 100. On the other hand, when the plate-like member 741 is in the non-accommodation state, the wireless board 20A is disposed in the vicinity of the communication sheet 100, so the beacon signal transmitted by the wireless board 20A propagates in the communication sheet 100. Similarly, the beacon signal transmitted from the wireless board 20B does not propagate within the communication sheet 100 when the plate-like member 742 is in the accommodation state, and propagates in the communication sheet 100 when the plate-like member 742 is in the non-accommodation state. In addition, the beacon signal transmitted from the wireless board 20C does not propagate in the communication sheet 100 when the plate-like member 743 is in the accommodation state, and propagates in the communication sheet 100 when the plate-like member 743 is in the non-accommodation state.

As described above, Use Example 4 is applied to the communication system including the plurality of communication devices (the wireless board 20A to 20C), the communication sheet 100, the terminal device 800, the support member (the signboard 720, the accommodating case 740, the plate-like members 741 to 743). The support member (the signboard 720, the accommodating case 740, the plate-like members 741 to 743) supports the plurality of communication devices (wireless boards 20A to 20C) such that one or more of the plurality of communication devices (wireless boards 20A to 20C) are disposed as a selected communication device at a position close to the communication sheet 10. Each of the plurality of communication devices (wireless boards 20A to 20C) transmits a beacon signal including guidance information associated with the own communication device. The communication sheet 100 propagates a beacon signal transmitted by one or more selected communication devices. Upon receiving the beacon signal in proximity to the communication sheet 100, the terminal device 800 outputs an image or a sound based on identification information of one or more selected communication devices.

According to such a configuration, the beacon signal transmitted from the wireless board 20, and the beacon signal transmitted from the wireless board adhered to the plate-like member (plate-like member in the non-accommodation state) corresponding to the selected shop, propagate within the communication sheet 100. When the terminal device 800 is brought close to the communication sheet 100, therefore, in addition to the map specifying information for specifying the map information, the current position information and the message information for urging the selection of the shop in order to specify the guidance information of the selected shop and the destination information indicating the location of the selected shop are obtained by the terminal device 800. Therefore, the terminal device 800 may output message information prompting selection of a shop as an image or voice. Further, the terminal device 800 may output the guidance information of the selected shop as an image or voice. The terminal device 800 may also display on the touch screen 810 an image showing on the map the relationship between the position of the selected shop and the current position and showing on the map a route that efficiently passes through the selected shop. Alternatively, the terminal device 800 may guide the route that efficiently passes through the shop selected from the current location based on a voice.

Use Example 4 also provides the same effect as Use Example 3 does. Furthermore, Use Example 4 makes it possible to select a wireless board that transmits a beacon signal propagating within the communication sheet 100. Therefore, Use Example 4 may permit a visitor to select information to be supplied to the user.

### Use Example 5

The description of Use Example 5 will be given of an example in which the communication sheet 100 is used for a pharmacy system in which a pharmacy manages information described in a medication notebook of a patient (hereinafter appropriately referred to as “notebook information”).

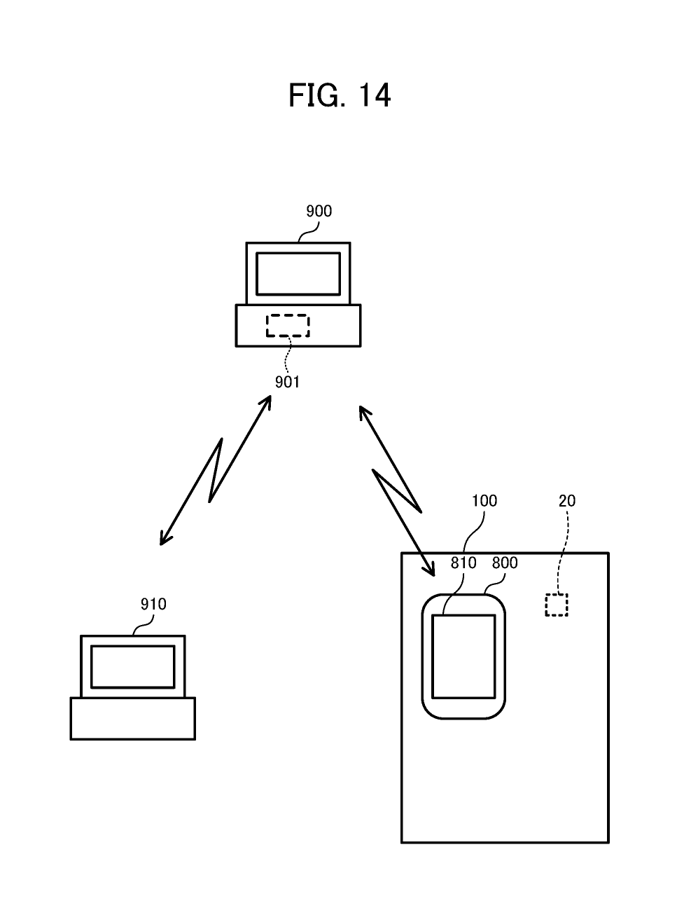

As shown in FIG. 14, the pharmacy system includes a communication sheet 100, a terminal device 800, a server 900, and a processor 910. The communication sheet 100 transmits a beacon signal including request information requesting permission to view the notebook information. Upon receiving the beacon signal from the communication sheet 100, the terminal device 800 transmits to the server 900 instruction information instructing that viewing of notebook information is permitted, and identification information of the terminal device 800. After receiving the instruction information and the identification information of the terminal device 800 from the terminal device 800, the server 900 permits the processor 910 to view the notebook information of the patient associated with the identification information of the terminal device 800 for a predetermined period (for example, 30 minutes). It is assumed that the server 900 has stored the identification information of the terminal device 800 owned by the patient, the identification information of the patient, and the notebook information of the patient in association with each other in the storage device 901.

As described above, Use Example 5 is applied to the communication system including the communication sheet 100, the terminal device 800, the server 900, and the processor 910. The communication sheet 100 transmits a beacon signal. Upon receiving the beacon signal in proximity to the communication sheet 100, the terminal device 800 transmits the identification information of the terminal device 800 to the server 900. Upon receiving the identification information of the terminal device 800 from the terminal device 800, the server 900 transmits information associated with the identification information of the terminal device 800 to the processor 910.

The conventional pharmacy system, for example, requires steps of causing the processor 910 to request the server 900 for viewing notebook information, causing the server 900 to issue an OTP (One Time Password) to the terminal device 800, and causes the patient who owns the terminal device 800 to notify a pharmacist of the OTP, and causes the pharmacist to operate the processor 910 to acquire notebook information from the server 900 using OTP. Accordingly, the conventional pharmacy system should go through very troublesome processes to view the notebook information.

By way of contrast, according to Use Example 5, to permit the processor 910 to view the notebook information, the patient has only to place the terminal device 800 on the communication sheet 100. With such a configuration, the patient may easily permit a pharmacy to browse the notebook information. Unlike the conventional communication device in which the beacon signal propagates in the three-dimensional space, Use Example 5 makes it possible to prevent the notebook information from being viewed for surrounding persons who do not desire to view the notebook information.

In Use Example 5, when a plurality of terminal devices 800 are placed on the communication sheet 100, viewing of the notebook information may be permitted. For example, when both of the terminal device 800 owned by a parent (hereinafter referred to as “terminal device A”) and the terminal device 800 owned by a child (hereinafter referred to as “terminal device B”) are placed on the communication sheet 100, so that viewing of the notebook information of the child is permitted. In this case, when the terminal device B is placed on the communication sheet 100, the terminal device B receives the beacon signal from the communication sheet 100, and transmits the instruction information and the identification information of the terminal device B to the server 900.

However, since the server 900 has not yet received the instruction information from the terminal device A at this stage, the server 900 does not permit viewing of the notebook information of the child. When the terminal device A is placed on the communication sheet 100, the terminal device A receives the beacon signal from the communication sheet 100, and transmits the instruction information and the identification information of the terminal device A to the server 900. Then, the server 900 receives the instruction information from both the terminal device B and the terminal device A associated with the terminal device B, and permits viewing of the notebook information of the child. It is assumed that the server 900 stores the identification information of the terminal device A and the identification information of the terminal device B in association with each other. Such a configuration makes it possible to inhibit permission to view the notebook information of the child based only on the determination of the child alone.

### Use Example 6

The description of Use Example 5 will be given of an example in which the communication sheet 100 including the wireless board 20 is used alone. The description of Use Example 6 will be given of an example in which the wireless board 20A and the wireless board 20B are used in addition to the communication sheet 100 including the wireless board 20. The description of Use Example 6 will be given of an example in which the wireless board 20A, the wireless board 20B, and the communication sheet 100 are used in a pharmacy system.

In Use Example 6, the wireless board 20 transmits a beacon signal including request information requesting permission to view the notebook information and message information prompting selection of the browse time of the notebook information. Further, the wireless board 20A transmits a beacon signal including information indicating a first viewing time (for example, 5 minutes). Further, the wireless board 20B transmits a beacon signal including information indicating a second viewing time (for example, 30 minutes). When only the terminal device 800 is placed on the communication sheet 100, the terminal device 800 receives the beacon signal including the request information and the message information from the wireless board 20, and displays the notebook information viewing time. Then, the patient places one of the wireless board 20A and the wireless board 20B as well as the terminal device 800 on the communication sheet 100.

When the wireless board 20A is placed on the communication sheet 100, the terminal device 800 receives a beacon signal including information indicating the first viewing time from the wireless board 20A, and transmits the request information and information indicating the first viewing time and the identification information of the terminal device 800 to the server 900. When the wireless board 20B is placed on the communication sheet 100, however, the terminal device 800 receives a beacon signal including information indicating the second viewing time from the wireless board 20B, and transmits the request information, the second viewing time, and the identification information of the terminal device 800 to the server 900.

When the server 900 receives the request information, the information indicating the first viewing time, and the identification information of the terminal device 800 from the terminal device 800, the server 900 permits the processor 910 to view the notebook information of the patient for the first viewing time. Upon receiving the request information, the information indicating the second viewing time, and the identification information of the terminal device 800 from the terminal device 800, however, the server 900 permits the processor 910 to view the notebook information of the patient for the second viewing time. Such a configuration may allow the patient to easily select the allowable time for viewing.

The wireless board 20A may transmit a beacon signal including identification information of the wireless board 20A in place of the information indicative of the first viewing time, and the wireless board 20B may transmit a beacon signal including the identification information of wireless board 20B in place of the information indicative of the second viewing time. In this case, upon receiving the beacon signal including the identification information of the wireless board 20A, the terminal device 800 transmits the request information, the identification information of the wireless board 20A, and the identification information of the terminal device 800 to the server 900. Further, upon receiving the beacon signal including the identification information of the wireless board 20B, the terminal device 800 transmits the request information, the identification information of the wireless board 20B, and the identification information of the terminal device 800 to the server 900. Upon receiving the request information, the identification information of the wireless board 20A, and the identification information of the terminal device 800 from the terminal device 800, the server 900 permits the processor 910 to view the notebook information of the patient for the first viewing time. Upon receiving the request information, the identification information of the wireless board 20B, and the identification information of the terminal device 800 from the terminal device 800, however, the server 900 permits the processor 910 to view the notebook information of the patient for the second viewing time.

As described above, Use Example 6 is applied to the communication system including a plurality of communication devices (wireless boards 20A to 20B), the communication sheet 100, the terminal device 800, the server 900, and the processor 910. Each of the plurality of communication devices (wireless boards 20A to 20B) transmits a beacon signal including identification information of the own communication device. One of the plurality of communication devices (wireless boards 20A to 20B) is disposed as a selected communication device at a position close to the communication sheet 100. Upon receiving the beacon signal in proximity to the communication sheet 100, the terminal device 800 transmits the identification information of the selected communication device and the identification information of the terminal device 800 to the server 900. Upon receiving the identification information of the selected communication device and the identification information of the terminal device 800 from the terminal device 800, the server 900 transmits the information associated with the identification information of the terminal device 800 within the period associated with the identification information of the selected communication device to the processor 910.

### Use Example 7

The description of Use Example 7 will be given of an example in which the communication sheet 100 is used for a smart lock system that manages locking of an object or equipment used by an unspecified number of users, such as car sharing, private accommodation, shared meeting rooms, and the like. This section describes the smart lock system in car sharing. In Use Example 7, the communication sheet 100, the terminal device 800, and the server 900 are used.

The communication sheet 100 includes the wireless board 20 that transmits a beacon signal including identification information of a vehicle on which the wireless board 20 is mounted. For example, the communication sheet 100 is disposed inside a door on the driver's sheet side of the vehicle in such a way that the thicknesswise direction is horizontal. The terminal device 800 has a function of receiving a beacon signal from the wireless board 20 and a function of wirelessly communicating with the server 900. The terminal device 800 is, for example, a smartphone. The server 900 is a server owned by a company that manages car sharing.

First, a user reserves a car using the terminal device 800. At this time, for example, the terminal device 800 acquires the identification information of the reserved vehicle from the server 900. Then, when the user uses the vehicle, the user brings the terminal device 800 closer to the door on the driver's sheet side of the vehicle. Then, the terminal device 800 receives the identification information of the vehicle from the wireless board 20. When the identification information of the vehicle received from the server 900 matches the identification information of the vehicle received from the wireless board 20, the terminal device 800 transmits an instructing signal to instruct unlocking the door to the management module that manages locking of the key of the door of the vehicle. Upon receiving the instruction signal from the terminal device 800, the management module unlocks the door.

As described above, Use Example 7 is applied to the communication system including the communication sheet 100, the terminal device 800, and the server 900. The communication sheet 100 is provided in a target facility (vehicle), and transmits a beacon signal including identification information of a target facility (vehicle). The server 900 transmits the identification information of the target facility (vehicle) to the terminal device 800. After receiving the identification information of the target facility (vehicle) from the server 900, the terminal device 800 outputs a control signal for using the target facility (vehicle) upon reception of the beacon signal in close proximity to the communication sheet 100.

Unlike the conventional communication device in which the beacon signal propagates in the three-dimensional space, Use Example 7 may prevent the situation in which the door of the vehicle is unlocked even though the terminal device 800 is located away from the vehicle. In some cases, the management module may adjust the position of the electric sheet, the angle of the backrest of the electric sheet, the angle of the room mirror, the side mirror, and the like. In this case, the terminal device 800 may store parameters indicating these positions and angles desired by the user, and transmit these parameters to the management module together with an instruction signal instructing unlocking of the vehicle. Then, the management module may adjust these positions and angles according to the received parameters.

### Use Example 8

The description of Use Example 7 has been given of the example in which the communication sheet 100 including the wireless board 20 is used alone. The description of Use Example 8 will be given of an example in which the wireless board 20A is used in addition to the communication sheet 100 including the wireless board 20. In Use Example 8, the wireless board 20A, the communication sheet 100, the server 900, and the processor 910 are used.

The wireless board 20 transmits a beacon signal including identification information of the vehicle. The wireless board 20A transmits a beacon signal including position information indicating a position where the wireless board 20A is disposed. The wireless board 20A is disposed in a parking lot, for example. Specifically, the wireless board 20A is disposed at a position behind the space in which the vehicle is parked, typically at a position close to the trunk or rear bumper of the parked vehicle. The communication sheet 100 has a function of transmitting a beacon signal transmitted from the wireless board 20 and a beacon signal transmitted from the wireless board 20A to the processor 910. The communication sheet 100 is provided, for example, inside the trunk or the rear bumper of the vehicle. The processor 910 receives a beacon signal from the wireless board 20 and the wireless board 20A via the communication sheet 100. The processor 910 is disposed in the vicinity of the communication sheet 100. The server 900 is a server owned by a company that manages car sharing.

First, while the vehicle carrying the communication sheet 100 and the processor 910 is not parked in the parking space where the wireless board 20 is disposed, the wireless board 20A and the communication sheet 100 do not come close to each other. Therefore, the processor 910 receives only the beacon signal transmitted by the wireless board 20, and does not receive the beacon signal transmitted by the wireless board 20A. On the other hand, while the vehicle is parked in the parking space where the wireless board 20A is disposed, the wireless board 20A and the communication sheet 100 are close to each other. Accordingly, the processor 910 receives the beacon signal transmitted by the wireless board 20 and the beacon signal transmitted by the wireless board 20A via the communication sheet 100. The processor 910 transmits the identification information of the vehicle included in the beacon signal received from the wireless board 20 and the position information included in the beacon signal received from the wireless board 20A to the server 900. Based on the position information received from the processor 910, the server 900 specifies the position of the vehicle on which the wireless board 20 is mounted.

As described above, Use Example 8 is applied to the communication system including the communication device (wireless board 20A), the communication sheet 100, the server 900, and the processor 910. The communication sheet 100 is disposed in a vehicle. The processor 910 is disposed in the vehicle and disposed in a position close to the communication sheet 100. The communication device (wireless board 20A) is placed in a parking lot where the vehicle is parked. The communication device (wireless board 20A) transmits a beacon signal including position information indicating the position of the parking lot. When the communication device (wireless board 20A) is close to the communication sheet 100 and receives the beacon signal, the processor 910 transmits the identification information and the position information of the vehicle to the server 900.

Use Example 8 makes it possible to specify in the car sharing whether the vehicle is in use or which parking space is parked.

### Use Example 9

The description of Use Example 9 will be given of an example in which the communication sheet 100 is used for a printing system including a printer that prints pictures and an input/output system that includes an ATM (Automatic Teller Machine) through which cash deposit or withdrawal is performed. An example applied to a printing system will be described next. In Use Example 9, the communication sheet 100, the terminal device 800, the server 900, and the processor 910 are used. It is assumed that the processor 910 is a printer.

The communication sheet 100 includes the wireless board 20 that transmits a beacon signal including identification information of the processor 910 on which the wireless board 20 is mounted. The communication sheet 100 is disposed, for example, at the top of the processor 910. The terminal device 800 has a function of receiving a beacon signal from the wireless board 20 and a function of wirelessly communicating with each of the server 900 and the processor 910. The terminal device 800 is, for example, a smartphone. The processor 910 has a function of wirelessly communicating with each of the terminal device 800 and the server 900, and a printing function. The server 900 is a server owned by a company that manages the print service.

First, the user uploads a digital image desired to be printed and the identification information of the terminal device 800 to the server 900 by using the terminal device 800. Then, the user brings the terminal device 800 closer to the communication sheet 100 disposed in the processor 910. At this time, the terminal device 800 receives the beacon signal including the identification information of the processor 910 from the communication sheet 100. The terminal device 800 transmits the identification information of the terminal device 800 and the identification information of the processor 910 to the processor 910.

Upon receiving the identification information of the terminal device 800 and the identification information of the processor 910 from the terminal device 800, the processor 910 determines that the user possessing the terminal device 800 is near the printer and executes processing for printing a picture. That is, the processor 910 transmits the received identification information of the terminal device 800 to the server 900. On the other hand, the server 900 transmits the digital image stored in association with the received identification information of the terminal device 800 to the processor 910. The processor 910 prints the received digital image.

As described above, Use Example 9 is applied to the communication system including the communication sheet 100, the terminal device 800, and the processor 910. The communication sheet 100 is provided in the processor 910, and transmits a beacon signal including identification information of the processor 910. Upon receiving the beacon signal in proximity to the communication sheet 100, the terminal device 800 transmits the identification information of the processor 910 and the identification information of the terminal device 800 to the processor 910. Upon the processor 910 receives the identification information of the processor 910 from the terminal device 800, the processor 910 executes processing based on the identification information of the terminal device 800.

In Use Example 9, if the user has previously uploaded the digital image to be printed to the server 900, in the shop where the processor 910 (printer) is disposed, the user just needs to move the terminal device 800 closer to the communication sheet 100 to obtain a digital image. Therefore, Use Example 9 makes it possible to reduce the labor of the user in the shop, which in turn is expected to suppress the congestion in the shop.

Use Example 9 may also be applied to a deposit/withdrawal system instead of a printing system. In this case, the processor 910 is an ATM, not a printer. Then, instead of the digital image, the terminal device 800 uploads the amount information indicating the amount of payment or the amount of withdrawal to the server 900. Then, when the user brings the terminal device 800 closer to the communication sheet 100, the cash deposit or withdrawal is executed by the ATM. Even in this example, it is possible to reduce the labor of the user in the shop, which in turn is expected to suppress the congestion in the store.

In Use Example 9, the server 900 may not be provided. In this case, information uploaded to the server 900 (for example, a digital image, amount information) is held by the terminal device 800. Then, when the terminal device 800 approaches the communication sheet 100, the terminal device 800 transmits the identification information of the processor 910 and those pieces of information (for example, a digital image, amount information) to the processor 910.

### Use Example 10

The description of Use Example 9 has been given of an example in which the communication sheet 100 including the wireless board 20 is used alone. The description of Use Example 10 will be given of an example using the wireless board 20A in addition to the communication sheet 100 including the wireless board 20 will be described. The description of Use Example 10 will be given of an example in which the wireless board 20A, the communication sheet 100, the terminal device 800, the server 900, and the processor 910 are used in the printing system.

The wireless board 20 transmits a beacon signal including message information prompting placement of the wireless board 20A on the communication sheet 100 and identification information of the wireless board 20. In Use Example 10, the wireless board 20 and the processor 910 correspond one to one to each other. Therefore, in place of the identification information of the wireless board 20, the identification information of the processor 910 may be adopted. In this case, the wireless board 20 transmits a beacon signal including the message information and the identification information of the processor 910. The wireless board 20A transmits a beacon signal including identification information of the terminal device 800. The wireless board 20A is carried by a user possessing the terminal device 800. The communication sheet 100 has a function of transmitting a beacon signal transmitted from the wireless board 20 and a beacon signal transmitted from the wireless board 20A to the terminal device 800. The communication sheet 100 is disposed, for example, on the top of the processor 910 (printer). The terminal device 800 has a function of receiving a beacon signal transmitted from the wireless board 20 and a beacon signal transmitted from the wireless board 20A, a function of wirelessly communicating with the processor 910, and a function of wirelessly communicating with the server 900. The processor 910 has a function of wirelessly communicating with each of the terminal device 800 and the server 900 and a printing function.

First, the user uploads the digital image desired to be printed and the identification information of the terminal device 800 to the server 900 by using the terminal device 800. Then, the user brings the terminal device 800 closer to the communication sheet 100 disposed in the processor 910. Then, the terminal device 800 receives the beacon signal transmitted from the wireless board 20, displays a message or outputs au audio message, the messages prompting to place the wireless board 20A on the communication sheet 100. Here, the user brings the wireless board 20A closer to the communication sheet 100 disposed in the processor 910. At this time, the wireless board 20A transmits a beacon signal including identification information of the terminal device 800 to the terminal device 800 via the communication sheet 100. The terminal device 800 receives from the wireless board 20 the beacon signal including the identification information of the wireless board 20 (or the identification information of the processor 910) and further receives from the wireless board 20A the beacon signal including the identification information of the terminal device 800, and then, the terminal device 800 determines that the user possessing the wireless board 20A and the terminal device 800 is near the processor 910, and transmits to the processor 910 a control signal for causing the processor 910 to execute processing for printing a photograph This control signal includes identification information of the terminal device 800. The processor 910 transmits the received identification information of the terminal device 800 to the server 900. Meanwhile, the server 900 transmits the digital image stored in association with the received identification information of the terminal device 800 to the processor 910. The processor 910 prints the received digital image.

As described above, Use Example 10 is applied to the communication system that includes the second communication device (the wireless board 20A), the communication sheet 100 including the first communication device (the wireless board 20), the terminal device 800, and the processor 910. The first communication device (the wireless board 20) transmits a beacon signal including identification information of the first communication device (or identification information of the processor 910). The second communication device (wireless board 20A) transmits a beacon signal including identification information of the terminal device 800. When the second communication device (the wireless board 20A) is close to the communication sheet 100 so that the terminal device 800 receives beacon signals transmitted from both the first communication device (the wireless board 20) and the second communication device (the wireless board 20A), the terminal device 800 transmits a control signal including identification information of the terminal device 800 to the processor 910. Upon receiving the control signal from the terminal device 800, the processor 910 executes processing based on the identification information of the terminal device 800.

In Use Example 10, if the user has previously uploaded the digital image to be printed to the server 900, in the shop where the processor 910 (printer) is disposed, the user just needs to bring the terminal device 800 and the wireless board 20A closer to the communication sheet 100 to obtain a digital image. Accordingly, Use Example 10 may make it possible to reduce the labor of the user in the shop, which in turn is expected to suppress the congestion in the shop.

In Use Example 10, when the terminal device 800 receives beacon signals from both the wireless board 20 and the wireless board 20A via the communication sheet 100, the terminal device 800 transmits a control signal including the identification information of the terminal device 800 to the processor 910. That is, in Use Example 10, unless both the wireless board 20A and the terminal device 800 are brought close to the communication sheet 100, the processing by the processor 910 is not executed. Therefore, even if a third party other than the owner of the terminal device 800 illegally acquires the terminal device 800, the third party cannot execute processing using the processor 910 unless the third party acquires the wireless board 20 too. According to Use Example 10, however, it is expected that a risk originated from the loss of the terminal device 800 may be reduced.

Like Use Example 9, Use Example 10 may be applied to a deposit/withdrawal system instead of a printing system. In Use Example 10, as in Use Example 9, the server 900 may not be provided.

### Use Example 11

The description of Use Example 11 will be given of an example in which the communication sheet 100 is used as the notification system at an educational site. In Use Example 11, communication sheets 100A to 100D, terminal devices 800A to 800D, and the server 900 are used.

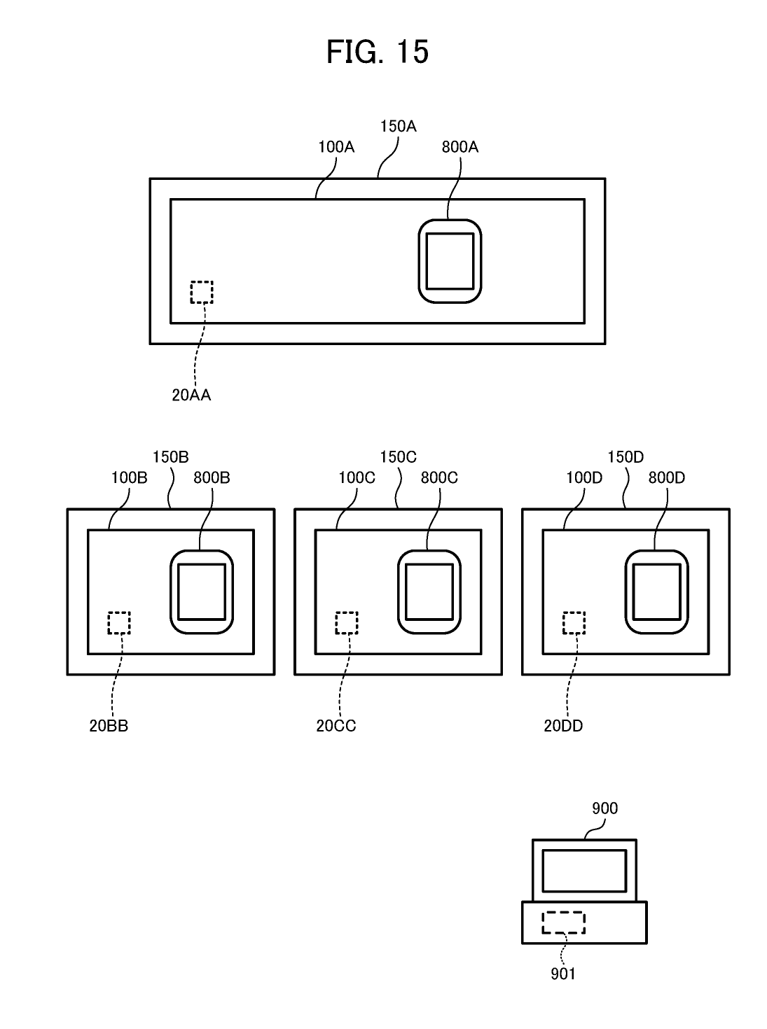

As shown in FIG. 15, the communication sheet 100A is laid on a desk 150A which is used by a teacher A, and includes a wireless board 20AA that transmits a beacon signal including identification information of the communication sheet 100A. The communication sheet 100B is laid on a desk 150B which is used by a student B, and includes a wireless board 20BB that transmits a beacon signal including identification information of the communication sheet 100B. The communication sheet 100C is laid on a desk 150C which is used by a student C, and includes a wireless board 20CC that transmits a beacon signal including identification information of the communication sheet 100C. The communication sheet 100D is laid on a desk 150D which is used by a student D, and includes a wireless board 20DD that transmits a beacon signal including identification information of the communication sheet 100D. In this manner, the communication sheets 100A to 100D transmit beacon signals including different identification information.

The terminal device 800A is owned by the teacher A. The terminal device 800B is owned by the student B. The terminal device 800C is owned by the student C. The terminal device 800D is owned by the student D. The server 900 receives various kinds of information from the terminal devices 800A to 800D, and transmits various kinds of information thereto.

When the student B places the terminal device 800B on the communication sheet 100B, the terminal device 800B transmits the identification information of the communication sheet 100B to the server 900. In turn, the server 900 transmits to the terminal device 800A that the identification information of the communication sheet 100B has been received. Similarly, when the student C places the terminal device 800C on the communication sheet 100C, the terminal device 800C transmits the identification information of the communication sheet 100C to the server 900. In turn, the server 900 transmits the identification information of the communication sheet 100C to the terminal device 800A. When the student D places the terminal device 800D on the communication sheet 100D, the terminal device 800D transmits the identification information of the communication sheet 100D to the server 900. In turn, the server 900 transmits the identification information of the communication sheet 100D to the terminal device 800A.

It is assumed herein that the server 900 and the terminal devices 800A to 800D respectively store information associating the identification information of the communication sheet 100A with the identification information of the teacher A, information associating the identification information of the communication sheet 100B with the identification information of the student B, information associating the identification information of the sheet 100C with the identification information of the student C, and information associating the identification information of the communication sheet 100D with the identification information of the student D. In this case, when the terminal device 800A receives the identification information of the communication sheet 100B, the terminal device 800A may determine the event as the student B having attended. Similarly, when receiving the identification information of the communication sheet 100C, the terminal device 800A may determine the event as the student C having attended. Further, when receiving the identification information of the communication sheet 100D, the terminal device 800A may determine the event as the student D having attended.

As described above, Use Example 11 is applied to the communication system including the communication sheets 100B to 100D, the first terminal devices (terminal device 800B to 800D), and the second terminal device (terminal device 800A). The communication sheets 100B to 100D transmit beacon signals including identification information of the communication sheets 100B to 100D. When the first terminal device (the terminal device 800B to 800D) receives the beacon signal close to the communication sheet 100B to 100D, the first terminal device transmits the identification information of the communication sheet 100B to 100D to the second terminal device (the terminal device 800A).

Note that the communication sheet 100B may transmit a beacon signal including the identification information of the student B. In this case, the terminal device 800B transmits the identification information of the student B to the server 900, and the server 900 transmits the identification information of the student B to the terminal device 800A. Alternatively, the terminal device 800B transmits the identification information of the student B to the server 900, and the server 900 transmits the information that the student B has attended to the terminal device 800A. Alternatively, the terminal device 800B transmits information that the student B attended to the server 900, and the server 900 transmits information that the student B has attended to the terminal device 800A. The same processing as has been done for the student B is also applied to the student C and student D.

In this manner, when the server 900 notifies the student identification number and the fact that the student has attended (that the student has placed the terminal on the communication sheet) to the terminal 800A, the terminal 800A notifies which student is present can be specified by the user. For this reason, the teacher A may check the attendance of the students by referring to the information displayed by the terminal device 800A without actually confirming the attendance of the students himself/herself. Note that the terminal device 800B may transmit the identification information of the communication sheet 100B, the identification information of the student B, or the fact that the student B has attended not to the server 900 but to the terminal device 800A. The same applies to the terminal device 800C and the terminal device 800D. Even such a configuration may allow the teacher A to check the attendance of the students with reference to the contents displayed by the terminal device 800A.

Further, when the terminal device 800B receives the identification information of the communication sheet 100B and the identification information of the student B from the communication sheet 100B, the terminal device 800B may activate an application that manages the progress status of the homework. As a result, the student B may inform the teacher A of the progress of the homework as well as his/her attendance. The teacher A may provide the student B with an appropriate homework in accordance with the progress of the homework by the student B (for example, instructing installation of an application of a homework whose level matches the progress onto the terminal device 800B). The same applies to the terminal device 800C and the terminal device 800D.

Further, when the teacher A places the terminal device 800A on the communication sheet 100A, the terminal device 800A may transmit the identification information of the communication sheet 100A and the identification information of the teacher A to the server 900. When the server 900 receives the identification information of the communication sheet 100A and the identification information of the teacher A from the terminal device 800A, the server 900 transmits the information for the teacher A to the terminal device 800A. Then, the terminal device 800A displays the received information for the teacher A. Upon receiving the identification information of the communication sheet 100B and the identification information of the student B from the terminal device 800B, the server 900 transmits the information for the student B to the terminal device 800B. Then, the terminal device 800B displays the received information for the student B. The server 900 may also transmit information for the student C and information for the student D to the terminal device 800C and the terminal device 800D.

Such a configuration may allow the attendees to view the information corresponding to the attendees or the information according to the authority of the attendees. Typically, the students B to D may be allowed to view the same information, or the teacher A may be allowed to view the information that cannot be viewed by the students B to D. Further, the terminal device 800A may cause the teacher A to view the above-mentioned information only while receiving the identification information of the communication sheet 100A or the identification information of the teacher A from the communication sheet 100A. The same applies to the terminal devices 800B to 800D.

### Use Example 12

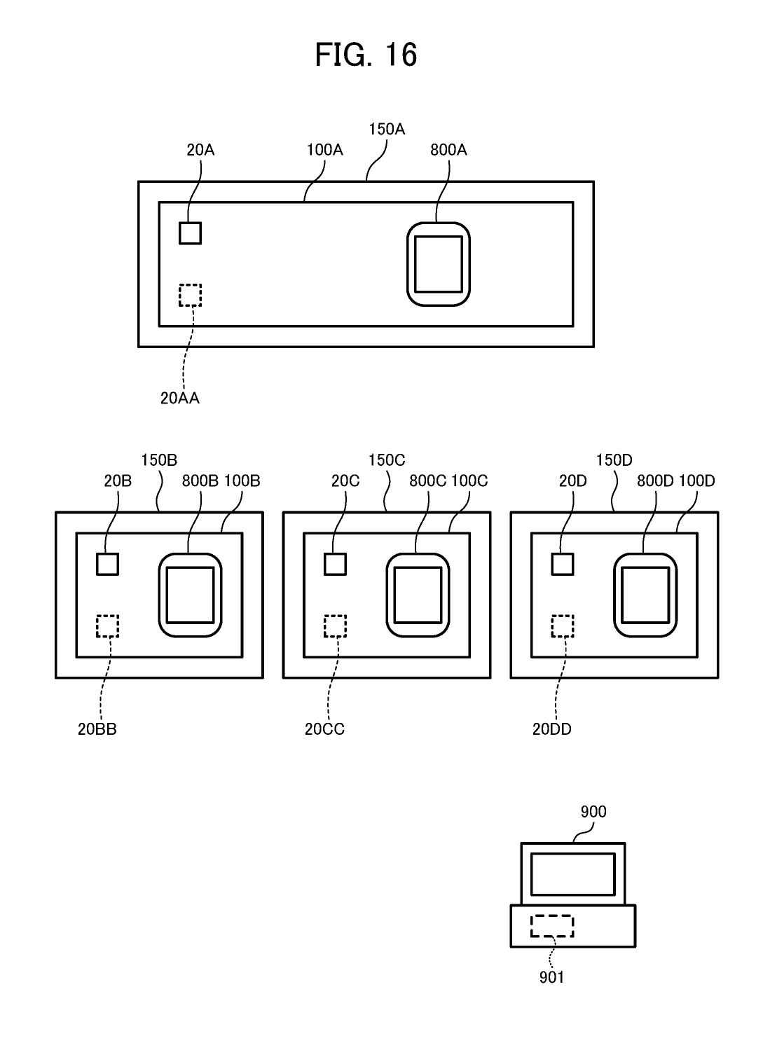

The description of Use Example 11 has been given of an example in which the communication sheet 100A including the wireless board 20AA or the like is used alone. The description of Use Example 12 will be given of an example using the wireless board 20A and the like in addition to the communication sheet 100A including the wireless board 20AA. In Use Example 12, as shown in FIG. 16, the wireless boards 20A to 20D, the communication sheets 100A to 100D, the terminal apparatuses 800A to 800D, the server 900, and the processor 910 are used.

The wireless board 20AA transmits a beacon signal including message information prompting placement of the wireless board 20A and the terminal device 800A on the communication sheet 100A. The wireless board 20BB transmits a beacon signal including message information prompting placement of the wireless board 20B and the terminal device 800B on the communication sheet 100B. The wireless board 20CC transmits a beacon signal including message information prompting placement of the wireless board 20C and the terminal device 800C on the communication sheet 100C. The wireless board 20DD transmits a beacon signal including message information prompting placement of the wireless board 20D and the terminal device 800D on the communication sheet 100D.

The wireless board 20A transmits a beacon signal including identification information of the wireless board 20A. The wireless board 20B transmits a beacon signal including identification information of the wireless board 20B. The wireless board 20C transmits a beacon signal including identification information of the wireless board 20C. The wireless board 20D transmits a beacon signal including identification information of the wireless board 20D. In this manner, the wireless boards 20A to 20D transmit beacon signals including different identification information. The communication sheets 100A to 100D have a function of transmitting a beacon signal.

First, when the student B places the terminal device 800B on the communication sheet 100B, the terminal device 800B receives the beacon signal transmitted from the wireless board 20BB via the communication sheet 100B. Then, the terminal device 800B displays image information or audio output message information prompting placement of the wireless board 20B on the communication sheet 100B. When the student B places the wireless board 20B on the communication sheet 100B, the terminal device 800B receives the beacon signal transmitted from the wireless board 20B via the communication sheet 100B. Then, the terminal device 800B transmits the identification information of the wireless board 20B included in the received beacon signal to the server 900. Meanwhile, the server 900 transmits the identification information of the wireless board 20B to the terminal device 800A. Such a configuration may allow the teacher A who owns the terminal device 800A to check the attendance of the student B. Likewise, the beacon signal transmitted from the wireless board 20C or the wireless board 20D allows the teacher A to check the attendance of the student C or the student D. Instead of the identification information of the wireless boards 20A to 20D, the identification information of the teacher A or the student B to D, or the information indicating the teacher A or information on the attendance of the student B-D may be transmitted and received.

Also, when the teacher A places the terminal device 800A on the communication sheet 100A, the terminal device 800A receives the beacon signal transmitted from the wireless board 20AA via the communication sheet 100A. Then, the terminal device 800A displays an image of, or outputs a voice of, message information prompting placement of the wireless board 20A on the communication sheet 100A. When the teacher A places the wireless board 20A on the communication sheet 100A, the terminal device 800A receives a beacon signal transmitted from the wireless board 20A via the communication sheet 100A. Then, the terminal device 800A transmits the identification information of the wireless board 20A included in the received beacon signal to the server 900. On the other hand, when receiving the identification information of the wireless board 20A, the server 900 transmits the information for the teacher A to the terminal device 800A. Then, the terminal device 800A displays the received information for the teacher A. Further, when receiving the identification information of the wireless board 20B from the terminal device 800B, the server 900 transmits the information for the student B to the terminal device 800B. Then, the terminal device 800B displays the received information for the student B. Similarly, the server 900 may also transmit information for the student C and information for the student D to the terminal device 800C and the terminal device 800D, respectively. Instead of the identification information of the wireless boards 20A to 20D, the identification information of the teacher A or the student B-D, or the information indicating the teacher A or information on the attendance of the student B-D may be transmitted and received.

In Use Example 12, while there is a functional difference between the wireless boards 20A to 20D, there is not a functional difference between the communication sheets 100A to 100D. For example, the student B may place the wireless board 20B and the terminal device 800B on the communication sheet 100C. Even in this case, the terminal device 800B receives the beacon signal transmitted from the wireless board 20B via the communication sheet 100C. Then, the terminal device 800B transmits the identification information of the wireless board 20B included in the received beacon signal to the server 900. Meanwhile, the server 900 transmits the identification information of the wireless board 20B to the terminal device 800A. Further, upon receiving the identification information of the wireless board 20B, the server 900 transmits the information for the student B to the terminal device 800B.

With determine to the notification of the attendance, there is not a functional difference between the terminal devices 800B to 800D. For example, if the student B may place any one of the terminal devices 800A to 800D if placed with the wireless board 20B. In viewing information, however, the information for the user that is specified by the identification information included in the beacon signal is transmitted to the terminal device owned by this user. It is therefore preferable that the user should use the terminal device owned by the user.

As apparent from the above, Use Example 12 is applied to the communication system including the communication devices (wireless boards 20B to 20D), the communication sheets 100B to 100D, the first terminal devices (terminal devices 800B to 800D), and the second terminal device (terminal device 800A). The first terminal devices (terminal devices 800B to 800D) are disposed at positions close to the communication sheets 100B to 100D. The communication device (wireless board 20B to 20D) transmits a beacon signal including identification information of the communication device (wireless board 20B to 20D). When the communication device (the wireless board 20B to 20D) approaches the communication sheet 100B to 100D, and the first terminal device (the terminal device 800B to 800D) receives the beacon signal, the first terminal device (the terminal device 800B to 800D) transmits identification information of the communication device (wireless board 20B to 20D) to the second terminal device (terminal device 800A).

According to Use Example 12, it is expected that the degree of freedom for achieving notification of the attendance and viewing of information is higher than that in

### Use Example 11

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be determined in an illustrative rather than a restrictive sense. This detailed description, therefore, is not to be taken in a limiting sense, and the scope of the invention is defined only by the included claims, along with the full range of equivalents to which such claims are entitled.

This application is based on Japanese Patent Application No. 2015-171205 filed on Aug. 31, 2015 and Japanese Patent Application No. 2016-134548 filed on Jul. 6, 2016. The specifications, claims, and drawings of Japanese Patent Application No. 2015-171205 and Japanese Patent Application No. 2016-134548 are incorporated herein by their entirety by reference.

### REFERENCE SIGNS LIST

10 First sheet-like conductor

11, 11a to 11d Linear conductor

12 Fixing member

13 Removal hole

20, 20A to 20D, 20AA to 20DD, 24 Wireless board

21 Meander line

22 Chip

23 Center line

25 Antenna pattern

30 Second sheet-like conductor

40 Metal tape

50 Sheet-like battery

51 Wiring

60 Dielectric

70 Protective film

80 Leaching region

90 Through hole

100, 100A to 100D, 110,120, 130, 200, 300, 400, 500, 600

Communication sheet

150A to 150D Desk

700 Water tank

710 to 712 Fish

720 Signboard

730 Rotating member

731-733 Region

734 Rotating shaft

740 Accommodating case

741 to 743 Plate-like member

800, 800a to 800d Terminal device

810 Touch screen

900 Server

901 Storage device

910 Processor

1. A communication sheet comprising:
a first sheet-like conductor having a plurality of openings defined by a plurality of intersecting linear conductors;
a second sheet-like conductor of a flat plate facing the first sheet-like conductor with a gap therebetween; and
a wireless board having a linear antenna parallel to one of the plurality of intersecting linear conductors.

2. The communication sheet according to claim 1, wherein
the wireless board is disposed on a major surface of the first sheet-like conductor so that a direction of current flowing through the linear antenna and the direction of interconnection of the one linear conductor are the same, and
the first sheet-like conductor includes a removal hole which is a contact region with the wireless board set on the major surface from which a region containing other linear conductors excluding the one linear conductor is removed.

3. The communication sheet according to claim 2, wherein
the linear antenna is partially or entirely a meander line,
the wireless board is disposed on the major surface of the first sheet-like conductor so that a center line of the meander line substantially overlaps the one linear conductor.

4. The communication sheet according to claim 2, wherein
the linear antenna is a linear antenna pattern, and
the wireless board is disposed on the major surface of the first sheet-like conductor so that the antenna pattern and the one linear conductor substantially overlap with each other.

5. The communication sheet according to claim 2, further comprising:
a dielectric provided between the first and second sheet-like conductors;
a through hole that directly underlies the removal hole and penetrates the dielectric and the second sheet-like conductor; and
a metal plate covering an opening portion of the through hole that faces the linear antenna from the second sheet-like conductor side.

6. The communication sheet according to claim 5, wherein
the metal plate is a metal tape for bonding the wireless board and the second sheet-like conductor via the through hole.

7. The communication sheet according to claim 5, further comprising:
a sheet-like battery that supplies power to the wireless board, the sheet-like battery being attached to a first surface of the second sheet-like conductor, the first surface being opposite to a second surface of the second sheet-like conductor where the second sheet-like conductor is in contact with the dielectric.

8. The communication sheet according to claim 1, wherein
in addition to the linear antenna, the wireless board includes a signal generator for generating a signal transmitted by the linear antenna, and
the first sheet-like conductor causes the signal transmitted from the linear antenna to propagate from the one linear conductor into the communication sheet and leach out from the plurality of openings to a near field.

9. The communication sheet according to claim 1, wherein
the first sheet-like conductor has a lattice shape having a plurality of openings defined by a plurality of intersecting linear conductors.

10. The communication sheet according to claim 1, wherein
the wireless board is a beacon that transmits a signal conforming to Bluetooth (registered trademark) Low Energy (BLE) from the linear antenna.

11. A communication system comprising the communication sheet according to claim 1, and a terminal device, wherein
the communication sheet transmits a beacon signal including guidance specifying information for specifying guidance information of an exhibit placed near the communication sheet, and
upon reception of the beacon signal in proximity to the communication sheet, the terminal device outputs an image or sound based on the guidance information.

12. The communication system according to claim 11, comprising a plurality of the communication sheets, and further comprising a server and a storage device, wherein
each of the plurality of communication sheets transmits a beacon signal including guidance specifying information for specifying guidance information of an exhibit placed near the local communication sheet and identification information of the local communication sheet,
the storage device stores position information indicating a position where each of the plurality of communication sheets is disposed,
upon reception of the beacon signal, the terminal device transmits, to the server, the identification information of the communication sheet which has transmitted the beacon signal and the identification information of the terminal device,
upon reception of the identification information of the communication sheet which has transmitted the beacon signal and the identification information of the terminal device from the terminal device, the server stores, in the storage device, history information in which the identification information of the communication sheet which has transmitted the beacon signal and the identification information of the terminal device, and time information indicating a time of the reception are associated with each other, and
the server outputs information indicating a route that the terminal device has moved based on the history information and the position information.

13. A communication system comprising the communication sheet according to claim 1 and a terminal device, wherein
the communication sheet transmits a beacon signal including position information indicating a position where the communication sheet is disposed, and
upon reception of the beacon signal in proximity to the communication sheet, the terminal device outputs an image or sound based on the position information.

14. A communication system comprising the communication sheet according to claim 1, a terminal device, a server, and a processor, wherein
the communication sheet transmits a beacon signal,
upon reception of the beacon signal in proximity to the communication sheet, the terminal device transmits the identification information of the terminal device to the server, and
upon reception of the identification information of the terminal device from the terminal device, the server transmits information associated with the identification information of the terminal device to the processor.

15. A communication system comprising the communication sheet according to claim 1, a terminal device, and a server, wherein
the communication sheet is provided in a target facility, and transmits a beacon signal including identification information of the target facility,
the server transmits the identification information of the target facility to the terminal device, and
after receiving the identification information of the target facility from the server, the terminal device outputs a control signal for using the target facility upon reception of the beacon signal in proximity to the communication sheet.

16. A communication system comprising the communication sheet according to claim 1, a terminal device, and a processor, wherein
the communication sheet is provided in the processor, and transmits a beacon signal including identification information of the processor,
upon reception of the beacon signal in proximity to the communication sheet, the terminal device transmits the identification information of the processor and the identification information of the terminal device to the processor, and
upon reception of the identification information of the processor from the terminal device, the processor executes processing based on the identification information of the terminal device.

17. A communication system comprising the communication sheet according to claim 1, a first terminal device, and a second terminal device, wherein
the communication sheet transmits a beacon signal including identification information of the communication sheet, and
upon reception of the beacon signal in proximity to the communication sheet, the first terminal device transmits the identification information of the communication sheet to the second terminal device.

18. The communication sheet according to claim 3, further comprising:
a dielectric provided between the first and second sheet-like conductors;
a through hole that directly underlies the removal hole and penetrates the dielectric and the second sheet-like conductor; and
a metal plate covering an opening portion of the through hole that faces the linear antenna from the second sheet-like conductor side.

19. The communication sheet according to claim 4, further comprising:
a dielectric provided between the first and second sheet-like conductors;
a through hole that directly underlies the removal hole and penetrates the dielectric and the second sheet-like conductor; and
a metal plate covering an opening portion of the through hole that faces the linear antenna from the second sheet-like conductor side.
